(19) United States
(12) Patent Application Publication
(10) Pub. No.: US 2023/0176269 A1
(43) Pub. Date: Jun. 8, 2023

(54) LAMINATED FILM, CIRCULARLY POLARIZING PLATE, AND DISPLAY DEVICE

(71) Applicant: FUJIFILM Corporation, Tokyo (JP)

(72) Inventors: Ayako MURAMATSU, Kanagawa (JP); Jun ISHIYAMA, Kanagawa (JP); Keisuke YOSHIMASA, Kanagawa (JP); Tomoaki YOKOTA, Kanagawa (JP); Hiroki KUWAHARA, Kanagawa (JP)

(73) Assignee: FUJIFILM Corporation, Tokyo (JP)

(21) Appl. No.: 18/061,799

(22) Filed: Dec. 5, 2022

(30) Foreign Application Priority Data
Dec. 7, 2021 (JP) 2021-198620

(51) Int. Cl. G02B 5/30; B32B 7/12; B32B 37/12; B32B 7/023

(52) U.S. Cl. CPC G02B 5/3016; B32B 7/12; B32B 37/12; B32B 7/023; B32B 2037/1253; B32B 2307/42; G02F 1/133541

(57) ABSTRACT

A laminated film includes a plurality of optically anisotropic layers, excellent in transparency, with few point defects, and exhibits little reflected light where the laminated film is applied to a display device brought into a black display state; and a circularly polarizing plate. The laminated film includes first, second, third, and fourth optically anisotropic layers, in order, in which the first, second, third, and fourth optically anisotropic layers are each formed by fixing an aligned liquid crystal compound, an adhesion layer selected from the group consisting of an adhesive layer, and a pressure sensitive adhesive layer is provided on only one of between the first and second optically anisotropic layers, between the second and third optically anisotropic layers, and between the third and fourth optically anisotropic layers, and the laminated film has a minimum transmittance of 60% or more in a wavelength range of 400 to 700 nm.

### CROSS-REFERENCE TO RELATED APPLICATIONS

The present application claims priority under 35 U.S.C. § 119 to Japanese Patent Application No. 2021-198620, filed on Dec. 7, 2021. The above application is hereby expressly incorporated by reference, in its entirety, into the present application.

### BACKGROUND OF THE INVENTION

### 1. Field of the Invention

The present invention relates to a laminated film, a circularly polarizing plate, and a display device.

### 2. Description of the Related Art

An optically anisotropic layer formed of a liquid crystal compound is applied in various fields such as a display field.

For example, JP6773887B discloses a phase difference film including a positive A plate, a first positive C plate, and a λ/4 plate, and a circularly polarizing plate including the phase difference film. More specifically, JP6773887B discloses a circularly polarizing plate having a polarizer, a positive A plate, a first positive C plate, a λ/4 plate, and a second positive C plate in this order, in which each layer is formed by bonding through an adhesive layer.

### SUMMARY OF THE INVENTION

The present inventors have found that, in a case where a phase difference film including a plurality of optically anisotropic layers is produced by the bonding method disclosed in JP6773887B and applied to a display device, and the obtained display device is brought into a black display state, a large amount of reflected light is observed and therefore it is necessary to reduce the amount of reflected light.

In addition, the film including an optically anisotropic layer is also required to have few point defects.

The present invention has been made in view of the above circumstances, and an object of the present invention is to provide a laminated film including a plurality of optically anisotropic layers, which is excellent in transparency, has few point defects, and exhibits little reflected light in a case where the laminated film is applied to a display device and the display device is brought into a black display state.

Another object of the present invention is to provide a circularly polarizing plate and a display device.

As a result of extensive studies to achieve the above objects, the present inventors have completed the present invention having the following configuration.

(1) A laminated film comprising a first optically anisotropic layer, a second optically anisotropic layer, a third optically anisotropic layer, and a fourth optically anisotropic layer in this order,

in which the first optically anisotropic layer, the second optically anisotropic layer, the third optically anisotropic layer, and the fourth optically anisotropic layer are each a layer formed by fixing an aligned liquid crystal compound,

an adhesion layer selected from the group consisting of an adhesive layer and a pressure sensitive adhesive layer is provided only one of between the first optically anisotropic layer and the second optically anisotropic layer, between the second optically anisotropic layer and the third optically anisotropic layer, and between the third optically anisotropic layer and the fourth optically anisotropic layer, and

the laminated film has a minimum transmittance of 60% or more in a wavelength range of 400 to 700 nm.

(2) The laminated film according to (1), in which the laminated film satisfies one or two of the requirements X1 to X3 which will be described later.

(3) The laminated film according to (1) or (2), in which the laminated film satisfies any one of the requirement Y1, Y2, or Y3 which will be described later.

(4) The laminated film according to any one of (1) to (3), in which the first optically anisotropic layer and the second optically anisotropic layer are in direct contact with each other, the adhesion layer is disposed between the second optically anisotropic layer and the third optically anisotropic layer, and the third optically anisotropic layer and the fourth optically anisotropic layer are in direct contact with each other.

(5) The laminated film according to any one of (1) to (4), in which the adhesion layer is a layer formed of an ultraviolet curable adhesive.

(6) The laminated film according to any one of (1) to (5), in which the laminated film has a thickness of 20 μm or less.

(7) The laminated film according to any one of (1) to (6), in which the laminated film has an in-plane retardation of 100 to 180 nm at a wavelength of 550 nm.

(8) A circularly polarizing plate comprising the laminated film according to any one of (1) to (7) and a polarizer.

(9) The circularly polarizing plate according to (8), in which a polymer film is not provided between the laminated film and the polarizer.

(10) A display device comprising the laminated film according to any one of (1) to (7) or the circularly polarizing plate according to (8) or (9).

According to an aspect of the present invention, it is possible to provide a laminated film including a plurality of optically anisotropic layers, which is excellent in transparency, has few point defects, and exhibits little reflected light in a case where the laminated film is applied to a display device and the display device is brought into a black display state.

According to another aspect of the present invention, it is possible to provide a circularly polarizing plate and a display device.

### BRIEF DESCRIPTION OF THE DRAWINGS

FIG. 1 is a schematic cross-sectional view showing one example of a laminated film of the present invention;

FIG. 2 is a schematic cross-sectional view showing another example of the laminated film of the present invention;

FIG. 3 is a schematic cross-sectional view showing another example of the laminated film of the present invention;

### DESCRIPTION OF THE PREFERRED EMBODIMENTS

Hereinafter, the present invention will be described in more detail.

The description of configuration requirements described below may be made based on representative embodiments of the present invention, but the present invention is not limited to such embodiments.

Any numerical range expressed using “to” in the present specification refers to a range including the numerical values before and after the “to” as a lower limit value and an upper limit value, respectively.

In the present specification, the term “(meth)acrylic” is used to mean “either or both of acrylic and methacrylic”. The term “(meth)acrylate” is used to mean “either or both of acrylate and methacrylate”. The term “(meth)acryloyl” is used to mean “either or both of acryloyl and methacryloyl”.

In the present invention, Re(λ) and Rth(λ) represent an in-plane retardation at a wavelength λ, and a thickness direction retardation at a wavelength k, respectively. Unless otherwise specified, the wavelength λ, is 550 nm.

In the present invention, Re(λ) and Rth(λ) are values measured at a wavelength λ, in AxoScan (manufactured by Axometrics, Inc.). By inputting an average refractive index ((nx+ny+nz)/3) and a film thickness (d (μm)) in AxoScan,

slow axis direction)(°)

Re(λ)=R0(λ)

Rth(λ)=((nx+ny)/2−nz)×d

are calculated.

Although R0(λ) is displayed as a numerical value calculated by AxoScan, it means Re(λ).

In the present specification, the average refractive index ((nx+ny+nz)/3) is measured using an Abbe refractometer (NAR-4T, manufactured by Atago Co., Ltd.) and using a sodium lamp (X, =589 nm) as a light source. In addition, in a case of measuring the wavelength dependence, it can be measured with a multi-wavelength Abbe refractometer DR-M2 (manufactured by Atago Co., Ltd.) in combination with an interference filter. In a case of a liquid crystal compound, the average refractive index can be measured by measuring a film immobilized into an optically isotropic phase by this method.

In addition, the values in Polymer Handbook (John Wiley & Sons, Inc.) and catalogs of various optical films can be used. The values of the average refractive index of main optical films are illustrated below: cellulose acylate (1.48), cycloolefin polymer (1.52), polycarbonate (1.59), polymethylmethacrylate (1.49), and polystyrene (1.59).

The term “light” in the present specification means an actinic ray or radiation, for example, an emission line spectrum of a mercury lamp, a far ultraviolet ray typified by an excimer laser, an extreme ultraviolet ray (EUV light), an X-ray, an ultraviolet ray, or an electron beam (EB). Of these, an ultraviolet ray is preferable.

In the present specification, the A plate and the C plate are defined as follows.

There are two types of A plates, a positive A plate (A plate which is positive) and a negative A plate (A plate which is negative). The positive A plate satisfies the relationship of Expression (A1) and the negative A plate satisfies the relationship of Expression (A2) in a case where a refractive index in a film in-plane slow axis direction (in a direction in which an in-plane refractive index is maximum) is defined as nx, a refractive index in an in-plane direction orthogonal to the in-plane slow axis is defined as ny, and a refractive index in a thickness direction is defined as nz. In addition, the positive A plate has an Rth showing a positive value and the negative A plate has an Rth showing a negative value.

nx>ny≈nz Expression (A1)

ny<nx≈nz Expression (A2)

It should be noted that the symbol “≈” encompasses not only a case where the both sides are completely the same as each other but also a case where the both sides are substantially the same as each other. The expression “substantially the same” means that, for example, a case where (ny−nz)×d (in which d is a thickness of a film) is −10 to 10 nm and preferably −5 to 5 nm is also included in “ny≈nz”; and a case where (nx−nz)×d is −10 to 10 nm and preferably −5 to 5 nm is also included in “nx≈nz”.

There are two types of C plates, a positive C plate (C plate which is positive) and a negative C plate (C plate which is negative). The positive C plate satisfies the relationship of Expression (C1) and the negative C plate satisfies the relationship of Expression (C2). In addition, the positive C plate has an Rth showing a negative value and the negative C plate has an Rth showing a positive value.

nz>>nx≈ny Expression (C1)

nz<nx≈ny Expression (C2)

It should be noted that the symbol “≈” encompasses not only a case where the both sides are completely the same as each other but also a case where the both sides are substantially the same as each other. The expression “substantially the same” means that, for example, a case where (nx−ny)×d (in which d is a thickness of a film) is 0 to 10 nm and preferably 0 to 5 nm is also included in “nx≈ny”.

In the present specification, the refractive index of an optically anisotropic layer such as an A plate, a C plate, and a layer formed by fixing a liquid crystal compound twist-aligned along a helical axis extending in a thickness direction is defined as in Expression (N1). In Expression (N1), nx means a refractive index in a layer in-plane slow axis direction (a direction in which the refractive index in the plane is maximized) in the same manner as above, and ny means the refractive index in a direction orthogonal to an in-plane slow axis in the plane also in the same manner as above.

(refractive index)=(nx+ny)/2 Expression (N1)

In a case where the optically anisotropic layer is an A plate, a C plate, or a layer formed by fixing a liquid crystal compound twist-aligned along the helical axis extending in a thickness direction, the refractive index is considered to be substantially uniform in a film thickness direction.

In addition, the refractive index of the adhesion layer is also calculated by Expression (N1). In a case where the adhesion layer is optically isotropic, the refractive index in any direction in the plane of the adhesion layer is defined as the refractive index.

The refractive index means a refractive index at a wavelength of 550 nm.

The refractive index can be measured using a reflection spectroscopic film thickness meter FE 3000 (manufactured by Otsuka Electronics Co., Ltd.) as shown in Examples which will be described later. Specifically, the refractive index can be calculated by measuring a reflectance spectrum of a layer whose refractive index is to be measured using the reflection spectroscopic film thickness meter FE 3000, and applying the n-Cauchy dispersion equation to the obtained reflectance spectrum.

A feature point of the laminated film according to the embodiment of the present invention is that the laminated film includes four optically anisotropic layers, has an adhesion layer disposed only at one place between the optically anisotropic layers, and therefore exhibits a predetermined transmittance.

As a result of studying the cause of a large amount of reflected light in a case where the phase difference film described in JP6773887B is used, the present inventors have found that the adhesion layer used for bonding each layer has an effect. In particular, in a case where an adhesion layer is disposed between two optically anisotropic layers, front reflection is likely to occur. In JP6773887B, since the four optically anisotropic layers are all bonded and disposed with an adhesion layer interposed therebetween, front reflection is likely to occur.

In addition, as a result of studying the cause of the point defects, the present inventors have found that the procedure during the production of an optically anisotropic layer may have an effect. For example, in a case where an optically anisotropic layer is produced by a coating step or the like, a winding step may be carried out after forming the optically anisotropic layer, and the present inventors have found that point defects are likely to occur in a case where such a treatment is carried out. In order to suppress the above-mentioned problems, it is preferable to carry out production by bonding of layers through an adhesion layer rather than production by continuously coating each layer.

Based on the above-mentioned findings, the present inventors have found that it is also possible to suppress the occurrence of point defects while reducing the amount of the reflected light by disposing an adhesion layer only at one predetermined place in a laminated film including four optically anisotropic layers.

Hereinafter, the laminated film according to the embodiment of the present invention will be described with reference to the accompanying drawings.

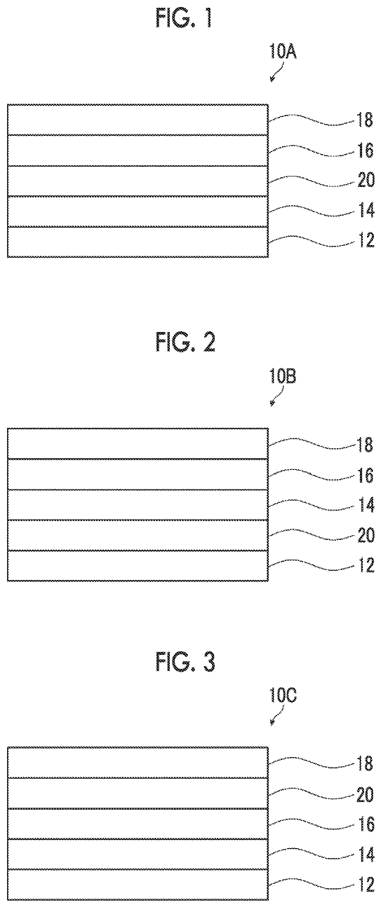

FIG. 1 shows a schematic cross-sectional view of an example of the laminated film according to the embodiment of the present invention. The laminated film 10A has a first optically anisotropic layer 12, a second optically anisotropic layer 14, a third optically anisotropic layer 16, and a fourth optically anisotropic layer 18 in this order, and has an adhesion layer 20 between the second optically anisotropic layer 14 and the third optically anisotropic layer 16.

As shown in FIG. 1, in the laminated film 10A, the adhesion layer 20 is disposed only between the second optically anisotropic layer 14 and the third optically anisotropic layer 16, and the adhesion layer 20 is not disposed between the first optically anisotropic layer 12 and the second optically anisotropic layer 14 and between the third optically anisotropic layer 16 and the fourth optically anisotropic layer 18.

In addition, although the adhesion layer 20 is disposed between the second optically anisotropic layer 14 and the third optically anisotropic layer 16 in FIG. 1, it is not limited to this aspect.

For example, a laminated film 10B, which is another example shown in FIG. 2, has a first optically anisotropic layer 12, a second optically anisotropic layer 14, a third optically anisotropic layer 16, and a fourth optically anisotropic layer 18 in this order, and has an adhesion layer 20 between the first optically anisotropic layer 12 and the second optically anisotropic layer 14.

As shown in FIG. 2, in the laminated film 10B, the adhesion layer 20 is disposed only between the first optically anisotropic layer 12 and the second optically anisotropic layer 14, and the adhesion layer 20 is not disposed between the second optically anisotropic layer 14 and the third optically anisotropic layer 16 and between the third optically anisotropic layer 16 and the fourth optically anisotropic layer 18.

Further, a laminated film 10C, which is another example shown in FIG. 3, has a first optically anisotropic layer 12, a second optically anisotropic layer 14, a third optically anisotropic layer 16, and a fourth optically anisotropic layer 18 in this order, and has an adhesion layer 20 between the third optically anisotropic layer 16 and the fourth optically anisotropic layer 18.

As shown in FIG. 3, in the laminated film 10C, the adhesion layer 20 is disposed only between the third optically anisotropic layer 16 and the fourth optically anisotropic layer 18, and the adhesion layer 20 is not disposed between the first optically anisotropic layer 12 and the second optically anisotropic layer 14 and between the second optically anisotropic layer 14 and the third optically anisotropic layer 16.

Although not shown in FIG. 1 to FIG. 3, as will be described later, a layer (for example, an alignment film or a substrate) other than the adhesion layer may be disposed between two adjacent optically anisotropic layers.

Hereinafter, each of members constituting the laminated film will be described in detail.

First Optically Anisotropic Layer to Fourth Optically Anisotropic Layer

The laminated film has four optically anisotropic layers, that is, a first optically anisotropic layer, a second optically anisotropic layer, a third optically anisotropic layer, and a fourth optically anisotropic layer.

The first optically anisotropic layer to the fourth optically anisotropic layer are layers different from each other. The layers different from each other are, for example, layers with different types of liquid crystal compounds used for forming an optically anisotropic layer, layers with different alignment morphologies or alignment directions of the liquid crystal compounds in the optically anisotropic layer, and layers with different optical properties (for example, in-plane retardation and thickness direction retardation) of the optically anisotropic layer.

The first optically anisotropic layer to the fourth optically anisotropic layer are each a layer formed by fixing an aligned liquid crystal compound, and preferably a layer formed by fixing a liquid crystal compound having a polymerizable group by polymerization.

In the present specification, the “fixed” state is a state in which the alignment of a liquid crystal compound is maintained. Specifically, the “fixed” state is preferably a state in which, in a temperature range of usually 0° C. to 50° C. or in a temperature range of −30° C. to 70° C. under more severe conditions, the layer has no fluidity and a fixed alignment morphology can be maintained stably without causing a change in the alignment morphology due to an external field or an external force.

The type of the liquid crystal compound is not particularly limited, and the liquid crystal compound can be generally classified into a rod-like liquid crystal compound and a disk-like liquid crystal compound according to its shape. Furthermore, there are a low molecular weight type and a high molecular weight type, respectively. The high molecular weight generally refers to having a polymerization degree of 100 or more (Polymer Physics-Phase Transition Dynamics, Masao Doi, p. 2, Iwanami Shoten Publishers, 1992). Any liquid crystal compound can be used in the present invention, and a rod-like liquid crystal compound or a discotic liquid crystal compound (disk-like liquid crystal compound) is preferable. In addition, a relatively low molecular weight liquid crystal compound which is a monomer or has a polymerization degree of less than 100 is preferable.

The liquid crystal compound preferably has a polymerizable group. That is, the liquid crystal compound is preferably a polymerizable liquid crystal compound. Examples of the polymerizable group contained in the polymerizable liquid crystal compound include an acryloyl group, a methacryloyl group, an epoxy group, and a vinyl group.

Polymerizing such a polymerizable liquid crystal compound makes it possible to fix the alignment of the liquid crystal compound. After the liquid crystal compound is fixed by polymerization, it is no longer necessary to exhibit liquid crystallinity.

For example, those described in claim 1 of JP1999-513019A (JP-H11-513019A) or paragraphs [0026] to [0098] of JP2005-289980A are preferable as the rod-like liquid crystal compound. For example, those described in paragraphs [0020] to [0067] of JP2007-108732A or paragraphs [0013] to [0108] of JP2010-244038A are preferable as the discotic liquid crystal compound.

In addition, a liquid crystal compound having reverse wavelength dispersibility may be used as the liquid crystal compound.

Examples of the alignment state that the liquid crystal compound can take include homogenous alignment, homeotropic alignment, hybrid alignment, twisted alignment, and tilt alignment. The twisted alignment represents an alignment state in which a liquid crystal compound is twisted from one main surface to the other main surface of an optically anisotropic layer with the thickness direction of the optically anisotropic layer as a rotation axis. In the twisted alignment, the twisted angle of the liquid crystal compound (twisted angle of the liquid crystal compound in an alignment direction) is usually more than 0° and 360° or less in many cases.

At least one of the first optically anisotropic layer, the second optically anisotropic layer, the third optically anisotropic layer, or the fourth optically anisotropic layer may be an A plate, a negative A plate, or a positive A plate.

The in-plane retardation of the negative A plate at a wavelength of 550 nm is not particularly limited, and is preferably 70 to 200 nm and more preferably 80 to 190 nm from the viewpoint that the performance of the circularly polarizing plate including the laminated film according to the embodiment of the present invention is more excellent.

The thickness direction retardation of the negative A plate at a wavelength of 550 nm is not particularly limited, and is preferably −100 to −35 nm and more preferably −95 to −40 nm from the viewpoint that the performance of the circularly polarizing plate including the laminated film according to the embodiment of the present invention is more excellent.

The in-plane retardation of the positive A plate at a wavelength of 550 nm is not particularly limited, and is preferably 40 to 280 nm and more preferably 60 to 150 nm nm from the viewpoint that the performance of the circularly polarizing plate including the laminated film according to the embodiment of the present invention is more excellent.

The thickness direction retardation of the positive A plate at a wavelength of 550 nm is not particularly limited, and is preferably 20 to 140 nm and more preferably 30 to 75 nm nm from the viewpoint that the performance of the circularly polarizing plate including the laminated film according to the embodiment of the present invention is more excellent.

In addition, at least one of the first optically anisotropic layer, the second optically anisotropic layer, the third optically anisotropic layer, or the fourth optically anisotropic layer may be a C plate, a negative C plate, or a positive C plate.

The in-plane retardation of the negative C plate at a wavelength of 550 nm is preferably 0 to 10 nm.

The thickness direction retardation of the negative C plate at a wavelength of 550 nm is not particularly limited, and is preferably 10 to 120 nm and more preferably 15 to 60 nm from the viewpoint that the performance of the circularly polarizing plate including the laminated film according to the embodiment of the present invention is more excellent.

The in-plane retardation of the positive C plate at a wavelength of 550 nm is preferably 0 to 10 nm.

The thickness direction retardation of the positive C plate at a wavelength of 550 nm is not particularly limited, and is preferably −120 to −10 nm and more preferably −100 to −30 nm nm from the viewpoint that the performance of the circularly polarizing plate including the laminated film according to the embodiment of the present invention is more excellent.

In addition, at least one of the first optically anisotropic layer, the second optically anisotropic layer, the third optically anisotropic layer, or the fourth optically anisotropic layer may be a layer formed by fixing a liquid crystal compound twist-aligned (a layer formed by fixing a liquid crystal compound twist-aligned along a helical axis extending in a thickness direction).

The liquid crystal compound used for the layer formed by fixing a liquid crystal compound twist-aligned is preferably a rod-like liquid crystal compound.

The twisted angle of the liquid crystal compound is preferably in a range of 10° to 180° and more preferably in a range of 30° to 90° from the viewpoint that the performance of the circularly polarizing plate including the laminated film according to the embodiment of the present invention is more excellent.

The value of a product And of a refractive index anisotropy Δn of the layer formed by fixing a liquid crystal compound twist-aligned at a wavelength of 550 nm and a thickness d of the layer formed by fixing the liquid crystal compound twist-aligned is not particularly limited, and is preferably 40 to 280 nm and more preferably 100 to 200 nm from the viewpoint that the performance of the circularly polarizing plate including the laminated film according to the embodiment of the present invention is more excellent.

The twisted angle and Δnd are measured using an AxoScan (polarimeter) device manufactured by Axometrics, Inc. and using device analysis software of Axometrics, Inc.

The thickness of each layer of the first optically anisotropic layer to the fourth optically anisotropic layer is not particularly limited, and is preferably 10 μm or less, more preferably 0.1 to 5.0 μm, and still more preferably 0.3 to 3.0 μm.

The thickness of each layer of the first optically anisotropic layer to the fourth optically anisotropic layer is intended to refer to an average thickness of each layer. The average thickness is obtained by measuring the thicknesses of any five or more points of each layer and arithmetically averaging the measured values.

One suitable aspect of the first optically anisotropic layer to the fourth optically anisotropic layer may be, for example, an aspect in which the first optically anisotropic layer is a negative C plate, the second optically anisotropic layer is a negative A plate, the third optically anisotropic layer is a layer formed by fixing a liquid crystal compound twist-aligned, and the fourth optically anisotropic layer is a positive C plate.

In a case of the above aspect, the angle formed by the in-plane slow axis on the surface of the second optically anisotropic layer on the third optically anisotropic layer side and the in-plane slow axis on the surface of the third optically anisotropic layer on the second optically anisotropic layer side is preferably in a range of 0° to 30°.

Adhesion Layer

The adhesion layer is a layer selected from the group consisting of an adhesive layer and a pressure sensitive adhesive layer.

The adhesive layer is a layer formed of an adhesive. Examples of the adhesive include a water-based adhesive, a solvent-based adhesive, an emulsion-based adhesive, a solvent-free adhesive, an active energy ray curable adhesive, and a heat curable adhesive. Examples of the active energy ray curable adhesive include an electron beam curable adhesive, an ultraviolet curable adhesive, and a visible light curable adhesive, among which an ultraviolet curable adhesive is preferable. That is, the adhesion layer is preferably a layer formed of an ultraviolet curable adhesive.

Specific examples of the active energy ray curable adhesive include a (meth)acrylate-based adhesive. Examples of the curable component in the (meth)acrylate-based adhesive include a compound having a (meth)acryloyl group and a compound having a vinyl group.

The thickness of the adhesive layer is not particularly limited, and is preferably 0.1 to 5 μm and more preferably 0.5 to 2 μm.

The pressure sensitive adhesive layer is a layer formed of a pressure sensitive adhesive. Examples of the pressure sensitive adhesive include a rubber-based pressure sensitive adhesive, an acrylic pressure sensitive adhesive, a silicone-based pressure sensitive adhesive, an urethane-based pressure sensitive adhesive, a vinyl alkyl ether-based pressure sensitive adhesive, a polyvinyl alcohol-based pressure sensitive adhesive, a polyvinyl pyrrolidone-based pressure sensitive adhesive, a polyacrylamide-based pressure sensitive adhesive, and a cellulose-based pressure sensitive adhesive, among which an acrylic pressure sensitive adhesive (pressure sensitive adhesive) is preferable.

The acrylic pressure sensitive adhesive is preferably a copolymer of a (meth)acrylate in which the alkyl group of the ester portion is an alkyl group having 20 or less carbon atoms such as a methyl group, an ethyl group, or a butyl group with a (meth)acrylic monomer having a functional group such as (meth)acrylic acid or hydroxyethyl (meth)acrylate.

The thickness of the pressure sensitive adhesive layer is not particularly limited, and is preferably 1 to 30 μm and more preferably 5 to 20 μm.

The adhesion layer can be adjusted in refractive index by a known means in order to adjust the difference in refractive index from an object to be bonded. For example, in order to increase the refractive index of the adhesion layer, it is also preferable to use a resin or monomer having a high refractive index, or a metal fine particle. The resin or monomer having a high refractive index is not particularly limited as long as the refractive index is 1.50 or more. Examples of the metal fine particle include inorganic particles such as an alumina particle, an alumina hydrate particle, a silica particle, a zirconia particle, and a clay mineral (for example, smectite). The refractive index can be adjusted to a predetermined value by changing the amount of the resin or monomer having a high refractive index, the metal fine particle, or the like.

Other Layers

The laminated film according to the embodiment of the present invention may have layers other than the above-mentioned first optically anisotropic layer to fourth optically anisotropic layer and adhesion layer.

Alignment Film

The laminated film according to the embodiment of the present invention may have an alignment film. The alignment film may be disposed between the optically anisotropic layers. From the viewpoint of reducing point defects caused by the process, it is preferable to form a composition layer (optically anisotropic layer) having an alignment control ability on the surface of the optically anisotropic layer without using an alignment film, rather than providing the alignment film.

The alignment film can be formed by means such as rubbing treatment of an organic compound (preferably a polymer), oblique vapor deposition of an inorganic compound, formation of a layer having microgrooves, or accumulation of an organic compound (for example, w-tricosanoic acid, dioctadecylmethylammonium chloride, or methyl stearate) by the Langmuir-Blodgett method (LB film).

In addition, there is also known an alignment film capable of expressing an alignment function by application of an electric field, application of a magnetic field, or light (preferably polarized light) irradiation.

The alignment film is preferably formed by a rubbing treatment of a polymer.

Examples of the alignment film include a photo-alignment film.

The thickness of the alignment film is not particularly limited as long as it can exhibit an alignment function, and is preferably 0.01 to 5.0 μm, more preferably 0.05 to 3.0 μm, and still more preferably 0.5 to 1.0 μm.

Substrate

The laminated film according to the embodiment of the present invention may have a substrate. From the viewpoint of reducing the thickness of the laminated film according to the embodiment of the present invention, it is preferable that the laminated film does not have a substrate between the optically anisotropic layers.

The substrate is preferably a transparent substrate. The transparent substrate is intended to refer to a substrate having a visible light transmittance of 60% or more, which preferably has a visible light transmittance of 80% or more and more preferably 90% or more.

The thickness of the substrate is not particularly limited, and is preferably 10 to 200 μm, more preferably 10 to 100 μm, and still more preferably 20 to 90 μm.

In addition, the substrate may consist of a plurality of layers laminated. In order to improve the adhesion of the substrate to the layer provided thereon, the surface of the substrate may be subjected to a surface treatment (for example, a glow discharge treatment, a corona discharge treatment, an ultraviolet (UV) treatment, or a flame treatment).

In addition, an adhesive layer (undercoat layer) may be provided on the substrate.

The substrate may be peelable from the laminated film.

Other Optically Anisotropic Layers

The laminated film according to the embodiment of the present invention may further have an optically anisotropic layer in addition to the first optically anisotropic layer to fourth optically anisotropic layer described above.

Characteristics of Laminated Film

The laminated film according to the embodiment of the present invention has a minimum transmittance of 60% or more in a wavelength range of 400 to 700 nm, which is excellent in transparency. Above all, from the viewpoint of more excellent transparency, the minimum transmittance is preferably 75% or more and more preferably more than 90%. The upper limit of the minimum transmittance is not particularly limited, and is often 99.9% or less.

In addition, the minimum transmittance of the laminated film according to the embodiment of the present invention in a wavelength range of 450 to 700 nm is not particularly limited as long as it satisfies the requirements of the minimum transmittance in the wavelength range of 400 to 700 nm is satisfied. The minimum transmittance is preferably 60% or more, more preferably 75% or more, and still more preferably more than 90% from the viewpoint that the transparency of the laminated film is more excellent. The upper limit of the minimum transmittance is not particularly limited, and is often 99.9% or less.

The minimum transmittance is measured using a spectrophotometer (UV-3150, manufactured by Shimadzu Corporation).

The optical properties of the laminated film according to the embodiment of the present invention are not particularly limited, and the in-plane retardation at a wavelength of 550 nm is preferably 100 to 180 nm and more preferably 130 to 150 nm from the viewpoint that the function of the laminated film as a circularly polarizing plate is more excellent.

The thickness direction retardation of the laminated film at a wavelength of 550 nm is not particularly limited, and is preferably −100 to 100 nm and more preferably −30 to 30 nm from the viewpoint that the function of the laminated film as a circularly polarizing plate is more excellent.

The thickness of the laminated film according to the embodiment of the present invention is not particularly limited and is often 100 μm or less. From the viewpoint of reducing the thickness, the thickness of the laminated film is preferably 20 μm or less and more preferably 10 The lower limit of the thickness of the laminated film is not particularly limited, and is often 5 μm or more.

The thickness of the laminated film is obtained by measuring the thicknesses of any five or more points of the laminated film and arithmetically averaging the measured values. That is, the above numerical values are average values.

In addition, the thickness of the laminated film means a total thickness of the members from the first optically anisotropic layer to the fourth optically anisotropic layer. For example, in a case where the laminated film has a first optically anisotropic layer to a fourth optically anisotropic layer, the first optically anisotropic layer and the second optically anisotropic layer are in direct contact with each other, an adhesion layer is disposed between the second optically anisotropic layer and the third optically anisotropic layer, and the third optically anisotropic layer and the fourth optically anisotropic layer are in direct contact with each other, the thickness of the laminated film means a total of the thickness of the first optically anisotropic layer to the fourth optically anisotropic layer and the thickness of the adhesion layer.

In addition, in a case where the laminated film further has an optically anisotropic layer different from the first optically anisotropic layer to the fourth optically anisotropic layer, the thickness of the laminated film means a total thickness of the portion sandwiched between the optically anisotropic layers farthest from each other in a thickness direction. For example, in a case where the laminated film has a first optically anisotropic layer to a fifth optically anisotropic layer, the first optically anisotropic layer and the second optically anisotropic layer are in direct contact with each other, an adhesion layer is disposed between the second optically anisotropic layer and the third optically anisotropic layer, the third optically anisotropic layer and the fourth optically anisotropic layer are in direct contact with each other, and the fourth optically anisotropic layer and the fifth optically anisotropic layer are in direct contact with each other, the thickness of the portion sandwiched between the first optically anisotropic layer and the fifth optically anisotropic layer, specifically a total of the thickness of the first optically anisotropic layer to the fifth optically anisotropic layer and the thickness of the adhesion layer corresponds to the thickness of the laminated film.

The laminated film preferably satisfies one or two of the requirements X1 to X3 from the viewpoint that the effect of the present invention is more excellent.

Requirement X1: The first optically anisotropic layer and the second optically anisotropic layer are in direct contact with each other or are laminated through an alignment film, and the alignment direction of the liquid crystal compound on the surface of the first optically anisotropic layer on a second optically anisotropic layer side and the alignment direction of the liquid crystal compound on the surface of the second optically anisotropic layer on a first optically anisotropic layer side are different from each other.

Requirement X2: The second optically anisotropic layer and the third optically anisotropic layer are in direct contact with each other or are laminated through an alignment film, and the alignment direction of the liquid crystal compound on the surface of the second optically anisotropic layer on a third optically anisotropic layer side and the alignment direction of the liquid crystal compound on the surface of the third optically anisotropic layer on the second optically anisotropic layer side are different from each other.

Requirement X3: The third optically anisotropic layer and the fourth optically anisotropic layer are in direct contact with each other or are laminated through an alignment film, and the alignment direction of the liquid crystal compound on the surface of the third optically anisotropic layer on a fourth optically anisotropic layer side and the alignment direction of the liquid crystal compound on the surface of the fourth optically anisotropic layer on the third optically anisotropic layer side are different from each other.

As an example of the case in which the alignment directions of the liquid crystal compounds are different from each other as described above, for example, in a case where an optically anisotropic layer formed by fixing a liquid crystal compound homogeneously aligned and an optically anisotropic layer formed by fixing a liquid crystal compound homeotropically aligned are in direct contact with each other, the alignment directions of both liquid crystal compounds are different from each other.

In the requirement X1, it is preferable that the first optically anisotropic layer and the second optically anisotropic layer are in direct contact with each other, in the requirement X2, it is preferable that the second optically anisotropic layer and the third optically anisotropic layer are in direct contact with each other, and in the requirement X3, it is preferable that the third optically anisotropic layer and the fourth optically anisotropic layer are in direct contact with each other.

The laminated film preferably satisfies any one of the requirement Y1, Y2, or Y3 from the viewpoint that reflected light is further reduced.

Requirement Y1: An adhesion layer is disposed between the first optically anisotropic layer and the second optically anisotropic layer, the difference between the refractive index of the adhesion layer and the refractive index of the first optically anisotropic layer is 0.10 or less (preferably 0.05 or less), and the difference between the refractive index of the adhesion layer and the refractive index of the second optically anisotropic layer is 0.10 or less (preferably 0.05 or less).

Requirement Y2: An adhesion layer is disposed between the second optically anisotropic layer and the third optically anisotropic layer, the difference between the refractive index of the adhesion layer and the refractive index of the second optically anisotropic layer is 0.10 or less (preferably 0.05 or less), and a difference between the refractive index of the adhesion layer and the refractive index of the third optically anisotropic layer is 0.10 or less (preferably 0.05 or less).

Requirement Y3: An adhesion layer is disposed between the third optically anisotropic layer and the fourth optically anisotropic layer, the difference between the refractive index of the adhesion layer and the refractive index of the third optically anisotropic layer is 0.10 or less (preferably 0.05 or less), and a difference between the refractive index of the adhesion layer and the refractive index of the fourth optically anisotropic layer is 0.10 or less (preferably 0.05 or less).

One suitable aspect of the laminated film according to the embodiment of the present invention may be, for example, an aspect in which the first optically anisotropic layer and the second optically anisotropic layer are in direct contact with each other, an adhesion layer is provided between the second optically anisotropic layer and the third optically anisotropic layer, and the third optically anisotropic layer and the fourth optically anisotropic layer are in direct contact with each other, from the viewpoint that the effect of the present invention is more excellent.

Method for Producing Laminated Film

The method for producing a laminated film is not particularly limited, and a known method can be used.

In order to form a state in which two optically anisotropic layers are in direct contact with each other, for example, a composition for forming an optically anisotropic layer containing a liquid crystal compound having a polymerizable group (preferably, containing a material that imparts an alignment control ability to the surface of the optically anisotropic layer (for example, a photo alignment polymer) in the composition for forming an optically anisotropic layer) onto a substrate to form an optically anisotropic layer, and then a composition for forming an optically anisotropic layer containing a liquid crystal compound having a polymerizable group is further applied onto the formed optically anisotropic layer to form a separate optically anisotropic layer, whereby it is possible to form a state in which the two optically anisotropic layers are in direct contact with each other.

In addition, in order to form a state in which the two optically anisotropic layers are disposed through an adhesion layer, for example, two separately prepared optically anisotropic layers can be bonded through the adhesion layer to form the above state.

As described above, the laminated film according to the embodiment of the present invention can be formed by using a combination of a method of applying a composition for forming an optically anisotropic layer containing a liquid crystal compound having a polymerizable group and a bonding method.

Hereinafter, as an example, the method for producing a laminated film will be shown in which the first optically anisotropic layer and the second optically anisotropic layer are in direct contact with each other, an adhesion layer is provided between the second optically anisotropic layer and the third optically anisotropic layer, and the third optically anisotropic layer and the fourth optically anisotropic layer are in direct contact with each other.

In a case of producing the laminated film, first, a composition for forming an optically anisotropic layer containing a liquid crystal compound having a polymerizable group (hereinafter, also simply referred to as “composition for forming an optically anisotropic layer”) is used to prepare a first film including a first optically anisotropic layer and a second optically anisotropic layer, which are in direct contact with each other, and a second film including a third optically anisotropic layer and a fourth optically anisotropic layer, which are in direct contact with each other.

The liquid crystal compound having a polymerizable group (hereinafter, also referred to as “polymerizable liquid crystal compound”) contained in the composition for forming an optically anisotropic layer is as described above. As described above, a rod-like liquid crystal compound and a disk-like liquid crystal compound are appropriately selected according to the characteristics of an optically anisotropic layer to be formed.

The content of the polymerizable liquid crystal compound in the composition for forming an optically anisotropic layer is preferably 60% to 99% by mass and more preferably 70% to 98% by mass with respect to the total solid content of the composition for forming an optically anisotropic layer.

The solid content means a component capable of forming an optically anisotropic layer, excluding a solvent, and even in a case where a component itself is in a liquid state, such a component is regarded as the solid content.

The composition for forming an optically anisotropic layer may contain a compound other than the liquid crystal compound having a polymerizable group.

For example, in order to twist-align the liquid crystal compound, it is preferable that the composition for forming an optically anisotropic layer contains a chiral agent. The chiral agent is added to twist-align a liquid crystal compound, but of course, it is not necessary to add the chiral agent in a case where the liquid crystal compound is a compound exhibiting an optical activity such as having an asymmetric carbon in a molecule. In addition, it is not necessary to add the chiral agent, depending on the production method and the twisted angle.

The chiral agent is not particularly limited in a structure thereof as long as it is compatible with the liquid crystal compound used in combination. Any of known chiral agents (for example, described in “Liquid Crystal Device Handbook” edited by the 142nd Committee of the Japan Society for the Promotion of Science, Chapter 3, 4-3, Chiral agents for TN and STN, p. 199, 1989) can be used.

The amount of the chiral agent used is not particularly limited and is adjusted such that the above-mentioned twisted angle is achieved.

The composition for forming an optically anisotropic layer may contain a polymerization initiator. The polymerization initiator used is selected according to the type of polymerization reaction, and examples thereof include a thermal polymerization initiator and a photopolymerization initiator.

The content of the polymerization initiator in the composition for forming an optically anisotropic layer is preferably 0.01% to 20% by mass and more preferably 0.5% to 10% by mass with respect to the total solid content of the composition for forming an optically anisotropic layer.

Examples of other components that may be contained in the composition for forming an optically anisotropic layer include a polyfunctional monomer, an alignment control agent (a vertical alignment agent and a horizontal alignment agent), a surfactant, an adhesion improver, a plasticizer, and a solvent, in addition to the foregoing components.

In addition, a photo-alignable compound (for example, a photo-alignable polymer) can also be mentioned as another component. The photo-alignable compound is a compound having a photo-alignable group, and the photo-alignable group can be arranged in a predetermined direction by irradiation with light.

In a case of preparing the first film, first, the composition for forming an optically anisotropic layer is applied onto a substrate, and the formed coating film is subjected to an alignment treatment to align a polymerizable liquid crystal compound in the coating film, and then subjected to a curing treatment to form a first optically anisotropic layer.

The substrate may be a temporary support that can be peeled off, as will be described later.

Examples of the method of applying the composition for forming an optically anisotropic layer include a curtain coating method, a dip coating method, a spin coating method, a printing coating method, a spray coating method, a slot coating method, a roll coating method, a slide coating method, a blade coating method, a gravure coating method, and a wire bar method.

The alignment treatment can be carried out by drying the coating film at room temperature or by heating the coating film. In a case of a thermotropic liquid crystal compound, the liquid crystal phase formed by the alignment treatment can generally be transferred by a change in temperature or pressure. In a case of a lyotropic liquid crystal compound, the liquid crystal phase formed by the alignment treatment can also be transferred by a compositional ratio such as an amount of solvent.

The conditions in a case of heating the coating film are not particularly limited, and the heating temperature is preferably 50° C. to 250° C. and more preferably 50° C. to 150° C., and the heating time is preferably 10 seconds to 10 minutes.

In addition, after the coating film is heated, the coating film may be cooled, if necessary, before a curing treatment (light irradiation treatment) which will be described later.

The method of the curing treatment carried out on the coating film in which the polymerizable liquid crystal compound is aligned is not particularly limited, and examples thereof include a light irradiation treatment and a heat treatment. Above all, from the viewpoint of manufacturing suitability, a light irradiation treatment is preferable, and an ultraviolet irradiation treatment is more preferable.

The irradiation conditions of the light irradiation treatment are not particularly limited, and an irradiation dose of 50 to 1,000 mJ/cm² is preferable.

The atmosphere during the light irradiation treatment is not particularly limited and is preferably a nitrogen atmosphere.

Next, the composition for forming an optically anisotropic layer is applied onto the formed first optically anisotropic layer, and the formed coating film is subjected to an alignment treatment to align a polymerizable liquid crystal compound in the coating film, and then subjected to a curing treatment to form a second optically anisotropic layer.

The procedure for forming the second optically anisotropic layer is the same as the procedure for forming the first optically anisotropic layer.

The first film including a first optically anisotropic layer and a second optically anisotropic layer, which are in direct contact with each other, is obtained by the above treatment.

Before applying the composition for forming an optically anisotropic layer for forming the second optically anisotropic layer onto the first optically anisotropic layer, the surface of the first optically anisotropic layer may be subjected to a rubbing treatment, if necessary. In addition, in a case where the photo-alignable polymer is unevenly distributed on the surface of the first optically anisotropic layer, the photo-alignable polymer on the surface of the first optically anisotropic layer may be aligned by irradiation with light to impart an alignment regulating force.

The second film including a third optically anisotropic layer and a fourth optically anisotropic layer, which are in direct contact with each other, is obtained by the same procedure as described above.

Next, the obtained first film and second film are bonded to each other through an adhesion layer.

In a case where an adhesive layer is used as the adhesion layer, for example, an adhesive is applied onto one surface side of the first film, the surface onto which the adhesive is applied is brought into contact with the second film to bond the first film and the second film and, if necessary, a curing treatment is carried out to obtain a desired laminated film. In a case where the adhesive is an ultraviolet curable adhesive, the curing treatment may be, for example, an ultraviolet irradiation treatment.

In addition, in a case where a pressure sensitive adhesive layer is used as the adhesion layer, for example, a pressure sensitive adhesive is applied onto one surface side of the first film, the surface onto which the pressure sensitive adhesive is applied is brought into contact with the second film to bond the first film and the second film, thereby obtaining a desired laminated film.

In addition, after the bonding, the substrates included in the first film and the second film may be peeled off, if necessary.

Although the production method of the aspect in which the first optically anisotropic layer and the second optically anisotropic layer are in direct contact with each other has been described above, an alignment film may be disposed between the first optically anisotropic layer and the second optically anisotropic layer.

Circularly Polarizing Plate

The laminated film according to the embodiment of the present invention may be used as a circularly polarizing plate in combination with a polarizer. The circularly polarizing plate is an optical element that converts unpolarized light into circularly polarized light.

The circularly polarizing plate according to the embodiment of the present invention having the above-described configuration is suitably used for antireflection applications of a display device such as a liquid crystal display device (LCD), a plasma display panel (PDP), an electroluminescent display (ELD), or a cathode tube display device (CRT).

The polarizer may be a member having a function of converting natural light into specific linearly polarized light, and examples thereof include an absorption type polarizer.

The type of the polarizer is not particularly limited, and a commonly used polarizer can be used. Examples of the polarizer include an iodine-based polarizer, a dye-based polarizer using a dichroic substance, and a polyene-based polarizer. The iodine-based polarizer and the dye-based polarizer are generally prepared by adsorbing iodine or a dichroic dye on a polyvinyl alcohol, followed by stretching.

A protective film may be disposed on one side or both sides of the polarizer.

The arrangement relationship between the absorption axis of the polarizer and the laminated film is not particularly limited, and the optimum arrangement is selected according to the type of the optically anisotropic layer included in the laminated film.

For example, in a case where, in the laminated film, the first optically anisotropic layer is a negative C plate, the second optically anisotropic layer is a negative A plate, the third optically anisotropic layer is a layer formed by fixing a liquid crystal compound twist-aligned, and the fourth optically anisotropic layer is a positive C plate, the angle formed by the absorption axis of the polarizer and the in-plane slow axis of the negative A plate is preferably in a range of 45° to 135°.

The circularly polarizing plate may have a member other than the laminated film according to the embodiment of the present invention and the polarizer.

The circularly polarizing plate may have an adhesion layer between the laminated film according to the embodiment of the present invention and the polarizer.

Examples of the adhesion layer include known pressure sensitive adhesive layers and adhesive layers.

In addition, the circularly polarizing plate may have a polymer film between the laminated film according to the embodiment of the present invention and the polarizer, and is preferably not provided with the polymer film from the viewpoint of reducing the thickness. The polymer film may be, for example, a cellulose acylate film.

The method for producing a circularly polarizing plate is not particularly limited and may be, for example, a known method.

For example, a method of bonding a polarizer and a laminated film through an adhesion layer can be mentioned.

Display Device

The laminated film and circularly polarizing plate according to the embodiment of the present invention can be suitably applied to a display device.

The display device according to the embodiment of the present invention has a display element and the above-mentioned laminated film or circularly polarizing plate.

In a case where the laminated film according to the embodiment of the present invention is applied to a display device, it is preferably applied as the above-mentioned circularly polarizing plate. In this case, the circularly polarizing plate is disposed on the viewing side, and the polarizer is disposed on the viewing side in the circularly polarizing plate.

The display element is not particularly limited, and examples thereof include an organic electroluminescence display element and a liquid crystal display element.

### EXAMPLES

Hereinafter, features of the present invention will be described in more detail with reference to Examples and Comparative Examples. The materials, amounts used, proportions, treatment details, treatment procedure, and the like shown in the following Examples can be appropriately changed without departing from the spirit and scope of the present invention. Therefore, the scope of the present invention should not be construed as being limited by the specific examples given below.

### Example 1

Preparation of Cellulose Acylate Film

The following composition was put into a mixing tank, stirred, and further heated at 90° C. for 10 minutes. Then, the obtained composition was filtered through a filter paper having an average pore diameter of 34 μm and a sintered metal filter having an average pore diameter of 10 μm to prepare a dope. The concentration of solid contents of the dope is 23.5% by mass, and the solvent of the dope is methylene chloride/methanol/butanol=81/18/1 (mass ratio).

Cellulose acylate dope

| | |
|---|---|
| Cellulose acylate | 100 parts by mass |
| (acetyl substitution degree: 2.86, viscosity | |
| average polymerization degree: 310) | |
| Sugar ester compound 1 (represented by Formula (S4)) | 6.0 parts by mass |
| Sugar ester compound 2 (represented by Formula (S5)) | 2.0 parts by mass |
| Silica particle dispersion | 0.1 parts by mass |
| (AEROSIL R972, manufactured by | |
| Nippon Aerosil Co., Ltd.) | |
| Solvent (methylene chloride/methanol/butanol) | |

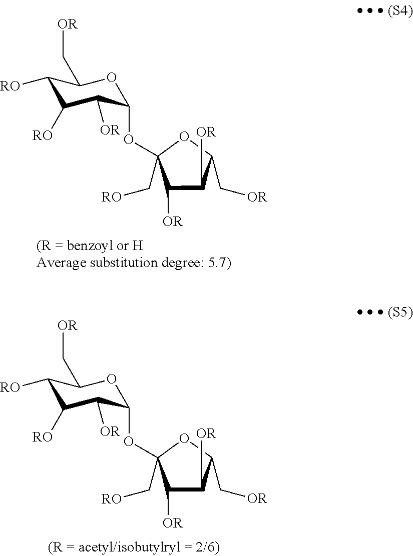

The dope prepared above was cast using a drum film forming machine. The dope was cast from a die such that it was in contact with a metal support cooled to 0° C., and then the obtained web (film) was stripped off. The drum was made of SUS.

The web (film) obtained by casting was peeled off from the drum and then dried in a tenter device for 20 minutes at 30° C. to 40° C. during film transport, using the tenter device that clips both ends of the web with clips to transport the film. Subsequently, the web was post-dried by zone heating while being rolled. The obtained web was knurled and then wound up.

The thickness of the obtained cellulose acylate film was 40 μm.

Formation of Laminated Film (1A)

A composition (1-1) for forming an optically anisotropic layer containing a rod-like liquid crystal compound having the following composition was applied onto the above-described cellulose acylate film using a geeser coating machine to form a composition layer. The film on which the composition layer was formed was heated with hot air at 116° C. for 1 minute, and irradiated with ultraviolet rays at an irradiation dose of 150 mJ/cm² using a 365 nm UV-LED while purging with nitrogen to achieve an atmosphere with an oxygen concentration of 100 ppm by volume or less at a temperature of 78° C. Then, the obtained coating film was annealed with hot air at 115° C. for 25 seconds to form an optically anisotropic layer (1-1) (which corresponds to a negative C plate) corresponding to the first optically anisotropic layer.

The obtained optically anisotropic layer (1-1) was irradiated with UV light (ultra-high pressure mercury lamp; UL750, manufactured by HOYA Corporation) passing through a wire grid polarizer at room temperature at an irradiation dose of 7.9 mJ/cm² (wavelength: 313 nm), whereby

an elongated film 1 was obtained in which the surface of the optically anisotropic layer (1-1) was endowed with an alignment control ability.

The film thickness of the formed optically anisotropic layer (1-1) was 0.9 The in-plane retardation Re at a wavelength of 550 nm was 0 nm, and the thickness direction retardation Rth at a wavelength of 550 nm was 40 nm. It was confirmed that the average tilt angle of the disc plane of the disk-like liquid crystal compound with respect to the film surface was 0°, and the disk-like liquid crystal compound was horizontally aligned with respect to the film surface.

Composition (1-1) for forming optically anisotropic layer

| | |
|---|---|
| Disk-like liquid crystal compound 1 given below | 4 parts by mass |
| Disk-like liquid crystal compound 2 given below | 1 part by mass |
| Disk-like liquid crystal compound 3 given below | 95.0 parts by mass |
| Polymerizable monomer 1 given below | 12.0 parts by mass |
| Polymerization initiator S-1 (oxime type) given below | 3.0 parts by mass |
| Photoacid generator D-1 given below | 3.0 parts by mass |
| Photo-alignable polymer A-1 given below | 0.6 parts by mass |
| Diisopropylethylamine | 0.2 parts by mass |
| o-Xylene | 475 parts by mass |

Disk-Like Liquid Crystal Compound 1

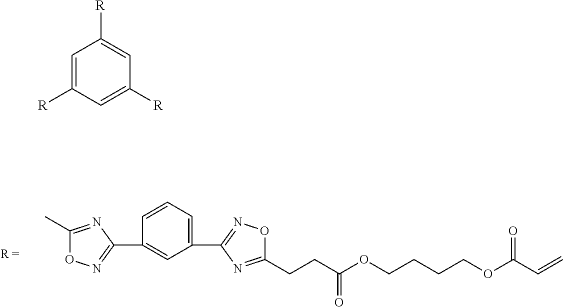

Disk-Like Liquid Crystal Compound 2

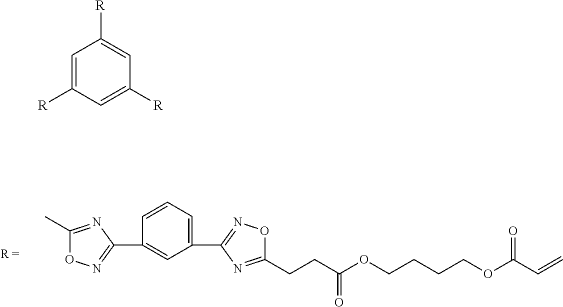

Disk-Like Liquid Crystal Compound 3

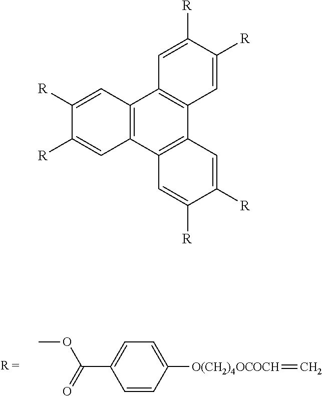

Polymerizable Monomer 1

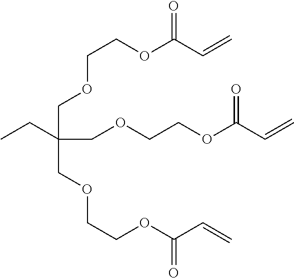 [SMILES: C=CC(=O)OCCOCC(CC)(COCCOC(=O)C=C)COCCOC(=O)C=C]

Polymerization Initiator S-1

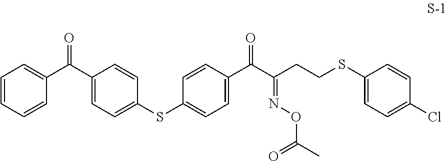 [SMILES: CC(=O)O/N=C(\CCSc1ccc(Cl)cc1)C(=O)c1ccc(Sc2ccc(C(=O)c3ccccc3)cc2)cc1]

Photoacid Generator D-1

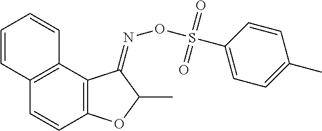 [SMILES: Cc1ccc(S(=O)(=O)O/N=C2/c3c(ccc4ccccc34)OC2C)cc1]

Photo-alignable polymer A-1 (The alphabet described in each repeating unit represents the content (% by mass) of each repeating unit with respect to all the repeating units, and a and b were 53% by mass and 47% by mass, respectively. In addition, the weight-average molecular weight was 183,000.)

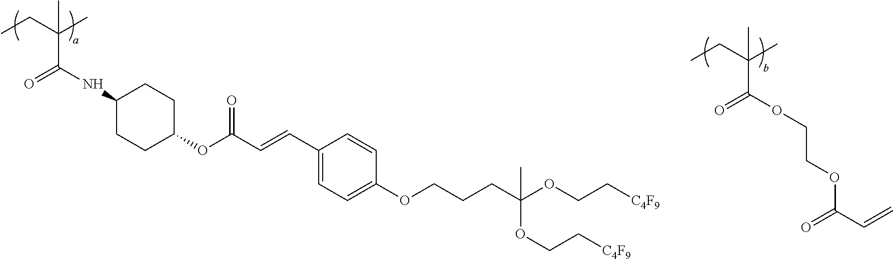

While continuously transporting the elongated film 1 without being wound up, a composition (1-2) for forming an optically anisotropic layer containing a rod-like liquid crystal compound having the following composition was applied onto the optically anisotropic layer (1-1) by using a geeser coating machine, and heated with hot air at 95° C. for 120 seconds. Subsequently, the obtained composition layer was irradiated with UV (100 mJ/cm²) at 95° C. to immobilize the alignment of the liquid crystal compound to form an optically anisotropic layer (1-2) (which corresponds to a negative A plate) corresponding to the second optically anisotropic layer.

The optically anisotropic layer (1-2) had a thickness of 1.5 μm and an in-plane retardation of 153 nm at a wavelength of 550 nm. It was confirmed that the average tilt angle of the disc plane of the disk-like liquid crystal compound with respect to the film surface was 90°, and the disk-like liquid crystal compound was aligned perpendicular to the film surface.

Assuming that the width direction of the film is defined as 0° (the counterclockwise direction is defined as 90° and the clockwise direction is defined as −90° in a longitudinal direction), the in-plane slow axis direction of the optically anisotropic layer (1-2) was −14° in a case of viewing from the optically anisotropic layer (1-2) side.

Composition (1-2) for forming optically anisotropic layer

| | |
|---|---|
| Disk-like liquid crystal compound 1 given above | 80 parts by mass |
| Disk-like liquid crystal compound 2 given above | 20 parts by mass |
| Alignment film interface alignment agent 1 given | 1.8 parts by mass |
| below | |
| Polymerizable monomer 1 given above | 10.0 parts by mass |
| Polymerization initiator S-1 (oxime type) given | 5.0 parts by mass |
| above | |
| Fluorine-containing compound A given below | 0.1 parts by mass |
| Fluorine-containing compound B given below | 0.21 parts by mass |
| Fluorine-containing compound C given below | 0.06 parts by mass |
| Anti-foaming agent 1 given below | 2.1 parts by mass |
| Methyl ethyl ketone | 299 parts by mass |

Alignment Film Interface Alignment Agent 1

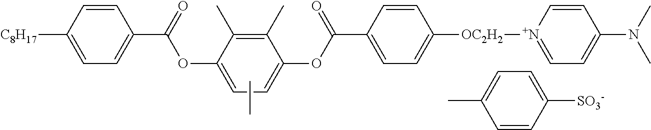

Fluorine-containing compound A (in the following formula, a and b represent the content (% by mass) of each repeating unit with respect to all the repeating units, a represents 90% by mass, and b represents 10% by mass)

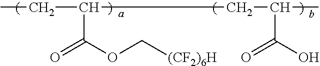

Fluorine-containing compound B (The numerical value in each repeating unit represents the content with respect to all the repeating units.)

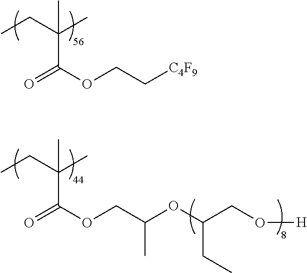

Fluorine-containing compound C (The numerical value in each repeating unit represents the content with respect to all the repeating units.)

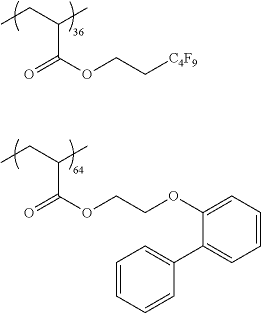

Anti-Foaming Agent 1

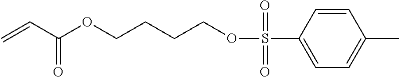 [SMILES: C=CC(=O)OCCCCOS(=O)(=O)c1ccc(C)cc1]

A laminated film (1A) having the optically anisotropic layer (1-1) and the optically anisotropic layer (1-2) directly laminated on an elongated cellulose acylate film and wound into a roll was obtained by the above procedure.

Formation of Laminated Film (1B)

A composition (1-4) for forming an optically anisotropic layer containing a rod-like liquid crystal compound having the following composition was applied onto the cellulose acylate film described in Example 1 using a geeser coating machine to form a composition layer. The film on which the composition layer was formed was heated with hot air at 60° C. for 1 minute, and irradiated with ultraviolet rays at an irradiation dose of 100 mJ/cm² using a 365 nm UV-LED while purging with nitrogen to achieve an atmosphere with an oxygen concentration of 100 ppm by volume or less. Then, the obtained coating film was annealed with hot air at 120° C. for 1 minute to form an optically anisotropic layer (1-4) (which corresponds to a positive C plate) corresponding to the fourth optically anisotropic layer.

The optically anisotropic layer (1-4) was irradiated with UV light (ultra-high pressure mercury lamp; UL750, manufactured by HOYA Corporation) passing through a wire grid polarizer at an irradiation dose of 7.9 mJ/cm² (wavelength: 313 nm) to obtain an elongated film 2 having a composition layer having an alignment control ability formed on the surface.

The film thickness of the formed optically anisotropic layer (1-4) was 0.7 The in-plane retardation Re at a wavelength of 550 nm was 0 nm, and the thickness direction retardation Rth at a wavelength of 550 nm was −85 nm. It was confirmed that the average tilt angle of the major axis direction of the rod-like liquid crystal compound with respect to the film surface was 90° and the rod-like liquid crystal compound was aligned perpendicular to the film surface.

Composition (1-4) for forming optically anisotropic layer

| | |
|---|---|
| Rod-like liquid crystal compound (A) | 100 parts by mass |
| given below | |
| Polymerizable monomer | 4.2 parts by mass |
| (A-400, manufactured by Shin-Nakamura | |
| Chemical Co., Ltd.) | |
| Polymerization initiator S-1 (oxime type) | 5.1 parts by mass |
| given above | |
| Photoacid generator D-1 given above | 3.0 parts by mass |
| Polymer M-1 given below | 5.1 parts by mass |
| Alignment film interface alignment agent | 1.9 parts by mass |
| 2 given below | |
| Photo-alignable polymer A-2 given below | 0.8 part by mass |
| Diisopropylethylamine | 0.2 parts by mass |
| Methyl ethyl ketone | 93.8 parts by mass |
| Methyl isobutyl ketone | 372.0 parts by mass |

Rod-like liquid crystal compound (A) (hereinafter, a mixture of compounds. Numerical values represent mass ratios.)

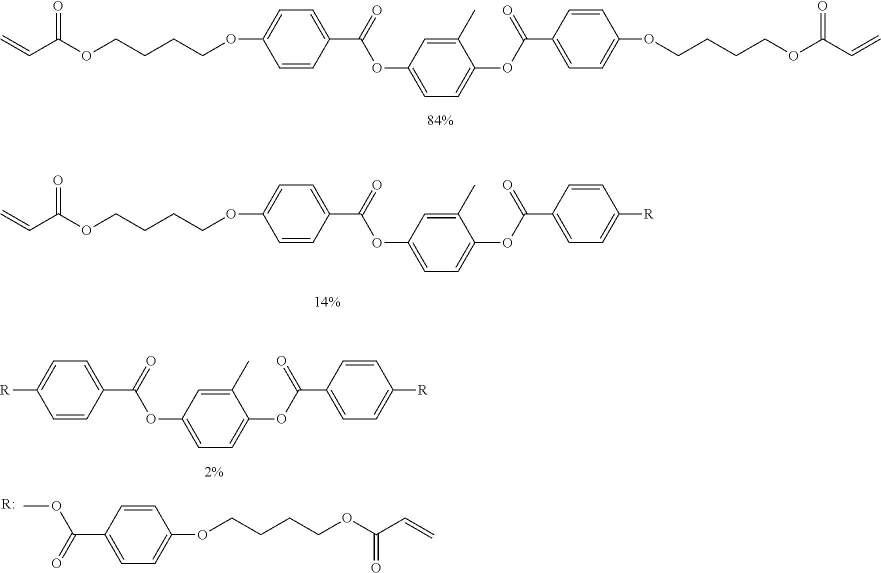

Polymer M-1 (Weight-Average Molecular Weight was 60,000)

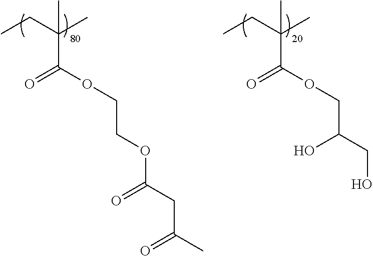

Alignment Film Interface Alignment Agent 2

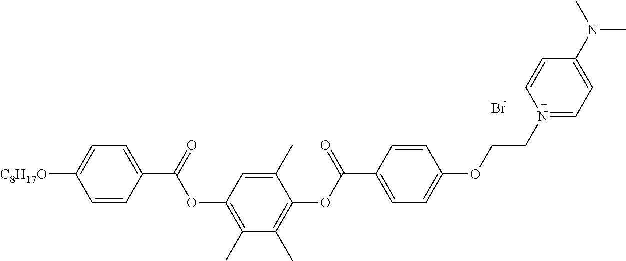

Photo-alignable polymer A-2 (In the following formula: a to c are a:b:c=17:64:19, and represent the content of each repeating unit with respect to all the repeating units in the polymer. The weight-average molecular weight was 100,000.)

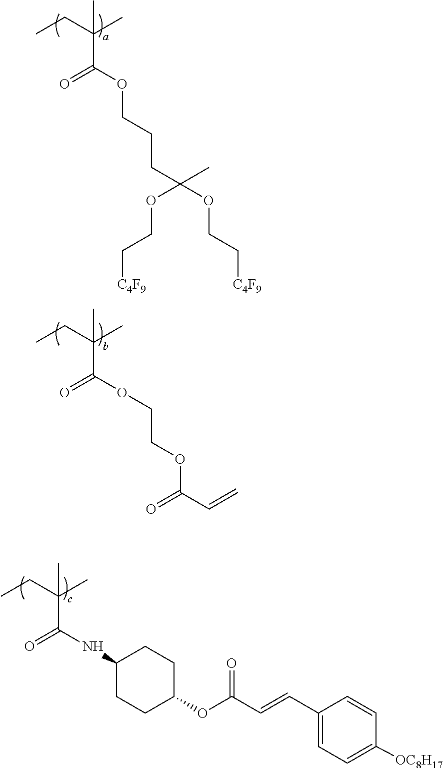

While continuously transporting the elongated film 2 without being wound up, a composition (1-3) for forming an optically anisotropic layer containing a rod-like liquid crystal compound having the following composition was applied onto the optically anisotropic layer (1-4) by using a geeser coating machine, and heated with hot air at 80° C. for 60 seconds. Subsequently, the obtained composition layer was irradiated with UV (500 mJ/cm²) at 80° C. to immobilize the alignment of the liquid crystal compound to form an optically anisotropic layer (1-3) (which corresponds to a layer formed by fixing a liquid crystal compound twist-aligned) corresponding to the third optically anisotropic layer.

The optically anisotropic layer (1-3) had a thickness of 1.25 And of 170 nm at a wavelength of 550 nm, and a twisted angle of a liquid crystal compound of 85°. Assuming that the width direction of the film is defined as 0° (the longitudinal direction of the film is defined as 90°), the in-plane slow axis direction (alignment axis angle of the liquid crystal compound) was 10° on the air side and 95° on the side in contact with the optically anisotropic layer (1-4), in a case of viewing from the optically anisotropic layer (1-3) side.

The in-plane slow axis direction of the optically anisotropic layer is expressed as negative in a case where it is clockwise (right-handed turning) and positive in a case where it is counterclockwise (left-handed turning) with the width direction of the substrate as a reference of 0°, upon observing the substrate from the surface side of the optically anisotropic layer.

Composition (1-3) for forming optically anisotropic layer

| | |
|---|---|
| Rod-like liquid crystal compound (A) given above | 100 parts by mass |
| Ethylene oxide-modified trimethylolpropane triacrylate | 4 parts by mass |
| (V# 360, manufactured by Osaka Organic Chemical | |
| Industry Ltd.) | |
| Photopolymerization initiator | 3 parts by mass |
| (IRGACURE 819, manufactured by BASF SE) | |
| Left-handed twisting chiral agent (L1) given below | 0.60 parts by mass |
| Fluorine-containing compound D given below | 0.08 parts by mass |
| Methyl ethyl ketone | 156 parts by mass |

Left-Handed Twisting Chiral Agent (L1)

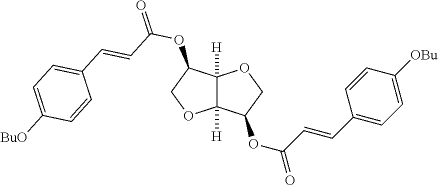

Fluorine-containing compound D (The numerical value in each repeating unit represents the content (% by mass) with respect to all the repeating units.)

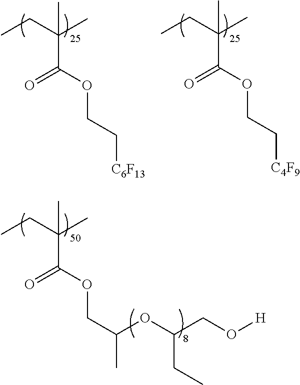

A roll-shaped laminated film (1B) in which the optically anisotropic layer (1-4) and the optically anisotropic layer (1-3) were directly laminated on an elongated cellulose acylate film was prepared by the above procedure.

Preparation of Laminated Film (1)

The liquid crystal-coated surface side of the above-prepared laminated film (1A) consisting of an elongated cellulose acylate film and the liquid crystal-coated surface side of the above-prepared laminated film (1B) formed on an elongated cellulose acylate film were each subjected to a corona treatment, and then continuously bonded using an ultraviolet curable adhesive composition (1) having the following composition so that the longitudinal directions of the films were parallel to each other.

The adhesive layer formed from the ultraviolet curable adhesive has a refractive index of 1.59, and the adjacent optically anisotropic layer (1-2) and optically anisotropic layer (1-3) have refractive indices of 1.59 and 1.57, respectively. The difference in refractive index between the adjacent optically anisotropic layer and the adhesive layer was 0.05 or less.

Ultraviolet curable adhesive composition (1)

| | |
|---|---|
| ARONIX UVX-6282 (manufactured by | 20 parts by mass |
| Toagosei Chemical Industry Co., Ltd.) | |
| LUMIPLUS LPK-2000 (manufactured by | 80 parts by mass |
| Mitsubishi Gas Chemical Company, Inc.) | |

Subsequently, the cellulose acylate film on the laminated film (1A) side was peeled off to expose the surface of the optically anisotropic layer (1-1) in contact with the cellulose acylate film. In this manner, an elongated laminated film (1) in which the optically anisotropic layer (1-1), the optically anisotropic layer (1-2), the adhesive layer, the optically anisotropic layer (1-3), and the optically anisotropic layer (1-4) were laminated in this order was obtained.

Preparation of Linearly Polarizing Plate

The surface of a support of a cellulose triacetate film TJ25 (manufactured by Fujifilm Corporation, thickness: 25 μm) was subjected to an alkali saponification treatment. Specifically, the support was immersed in a 1.5 N sodium hydroxide aqueous solution at 55° C. for 2 minutes, washed in a water bath at room temperature, and further neutralized with 0.1 N sulfuric acid at 30° C. After neutralization, the support was washed in a water bath at room temperature and further dried with hot air at 100° C. to obtain a polarizer protective film.

A roll-like polyvinyl alcohol (PVA) film having a thickness of 60 μm was continuously stretched in an aqueous iodine solution in a longitudinal direction and dried to obtain a polarizer having a thickness of 13 The visibility corrected single transmittance of the polarizer was 43%. At this time, the absorption axis direction and the longitudinal direction of the polarizer were the same.

The polarizer protective film was bonded to one surface of the polarizer using the following PVA adhesive to prepare a linearly polarizing plate.

Preparation of PVA Adhesive

100 parts by mass of a polyvinyl alcohol-based resin having an acetoacetyl group (average degree of polymerization: 1200, degree of saponification: 98.5 mol %, degree of acetoacetylation: 5 mol %) and 20 parts by mass of methylol melamine were dissolved in pure water under a temperature condition of 30° C. to prepare a PVA adhesive as an aqueous solution adjusted to a concentration of solid contents of 3.7% by mass.

Preparation of Circularly Polarizing Plate (P1)

The surface of the optically anisotropic layer (1-1) of the above prepared elongated laminated film (1) and the surface of the polarizer (the surface opposite to the polarizer protective film) of the above prepared elongated linearly polarizing plate were continuously bonded to each other using a pressure sensitive adhesive OPTERIA NCF-D692 (5 manufactured by Lintec Corporation). Subsequently, the cellulose acylate film on the optically anisotropic layer (1-4) side was peeled off to expose the surface of the optically anisotropic layer (1-4) in contact with the cellulose acylate film.

In this manner, a circularly polarizing plate (P1) consisting of the laminated film (1) and the linearly polarizing plate was prepared. At this time, the polarizer protective film, the PVA adhesive, the polarizer, the pressure sensitive adhesive, the optically anisotropic layer (1-1), the optically anisotropic layer (1-2), the adhesive layer, the optically anisotropic layer (1-3), and the optically anisotropic layer (1-4) were laminated in this order, and the angle formed by the absorption axis of the polarizer and the in-plane slow axis of the optically anisotropic layer (1-2) was 76°. In addition, the in-plane slow axis direction on the surface of the optically anisotropic layer (1-3) on the optically anisotropic layer (1-2) side was 10°, with the width direction as a reference of 0°. The angle formed by the in-plane slow axis direction of the optically anisotropic layer (1-3) and the in-plane slow axis direction of the optically anisotropic layer (1-2) was 4°. In addition, the in-plane slow axis direction on the surface of the optically anisotropic layer (1-3) on the optically anisotropic layer (1-4) side was 95°, with the width direction as a reference of 0°.

The thickness of the circularly polarizing plate (P1) was 49 μm.

### Example 2

A laminated film (2) and a circularly polarizing plate (P2) were prepared in the same manner as in Example 1, except that the following ultraviolet curable adhesive composition (2) was used instead of the ultraviolet curable adhesive composition (1). The refractive index of the adhesive layer was 1.51, and the difference in refractive index between the adhesive layer and the adjacent optically anisotropic layer (1-2) and optically anisotropic layer (1-3) was greater than 0.05.

Ultraviolet curable adhesive composition (2)

| | |
|---|---|
| ARONIX UVX-6282 (manufactured by | 80 parts by mass |
| Toagosei Chemical Industry Co., Ltd.) | |
| LUMIPLUS LPK-2000 (manufactured by | 20 parts by mass |
| Mitsubishi Gas Chemical Company, Inc.) | |

### Example 3

A laminated film (3) and a circularly polarizing plate (P3) were prepared in the same manner as in Example 1, except that the laminated films (1A) and (1B) were bonded to each other using a pressure sensitive adhesive OPTERIA NCF-D692 (5 manufactured by Lintec Corporation) instead of the ultraviolet curable adhesive. The refractive index of the pressure sensitive adhesive layer was 1.48, and the difference in refractive index between the pressure sensitive adhesive layer and the adjacent optically anisotropic layer (1-2) and optically anisotropic layer (1-3) was greater than 0.05. In addition, the difference in refractive index between the pressure sensitive adhesive layer and the optically anisotropic layer (1-2) was more than 0.10.

### Example 4

Preparation of Laminated Film (4A)

The optically anisotropic layer (1-1) prepared by the method of Example 1 was wound up to obtain a roll-shaped laminated film (1A-1). Subsequently, while transporting the laminated film (1A-1), the surface of the optically anisotropic layer (1-1) was subjected to a corona treatment, and then the following composition (4) for forming a photo-alignment film was applied using a geeser coating machine and dried at 80° C. for 1 minute. Then, the obtained coating film was irradiated with UV light (ultra-high pressure mercury lamp; UL750, manufactured by HOYA Corporation) passing through a wire grid polarizer at an irradiation dose of 10 mJ/cm² (wavelength: 313 nm) to form a photo-alignment film on the surface of the optically anisotropic layer (1-1).

The film thickness of the formed photo-alignment film was 0.2 μm.

Composition (4) for forming photo-alignment film

| | |
|---|---|
| Photo-alignable polymer A-3 given below | 5 parts by mass |
| Cyclopentanone | 95 parts by mass |

Photo-alignable polymer A-3 (Me represents a methyl group. Weight-average molecular weight: 30,000)

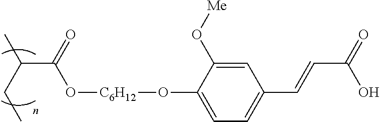

Subsequently, the composition (1-2) for forming an optically anisotropic layer described in Example 1 was applied onto the photo-alignment film using a geeser coating machine while continuously transporting the elongated film without being wound up and heated with hot air at 95° C. for 120 seconds. Subsequently, the obtained composition layer was irradiated with UV (100 mJ/cm²) at 95° C. to immobilize the alignment of the liquid crystal compound to form an optically anisotropic layer (4-2) corresponding to the second optically anisotropic layer.

The optically anisotropic layer (4-2) had a thickness of 1.5 μm and an in-plane retardation of 153 nm at a wavelength of 550 nm. It was confirmed that the average tilt angle of the disc plane of the disk-like liquid crystal compound with respect to the film surface was 90°, and the disk-like liquid crystal compound was aligned perpendicular to the film surface.

Assuming that the width direction of the film is defined as 0° (the counterclockwise direction is defined as 90° and the clockwise direction is defined as −90° in a longitudinal direction), the in-plane slow axis direction of the optically anisotropic layer (4-2) was −14° in a case of viewing from the optically anisotropic layer (1-1) side.

A laminated film (4A) having the optically anisotropic layer (1-1), the photo-alignment film, and the optically anisotropic layer (4-2) laminated in this order on an elongated cellulose acylate film and wound into a roll was obtained by the above procedure.

A laminated film (4) and a circularly polarizing plate (P4) were prepared in the same manner as in Example 1, except that the laminated film (4A) was used instead of the laminated film (1A).

Preparation of Laminated Film (5B)

The optically anisotropic layer (1-4) prepared by the method of Example 1 was wound up to obtain a roll-shaped laminated film (1B-1). Subsequently, while transporting the laminated film (1B-1), the surface of the optically anisotropic layer (1-4) was subjected to a corona treatment, and the composition (4) for forming a photo-alignment film described in Example 4 was applied using a geeser coating machine and dried at 80° C. for 1 minute. Then, the obtained coating film was irradiated with UV light (ultra-high pressure mercury lamp; UL750, manufactured by HOYA Corporation) passing through a wire grid polarizer at an irradiation dose of 10 mJ/cm² (wavelength: 313 nm) to form a photo-alignment film on the surface of the optically anisotropic layer (1-4).

The film thickness of the formed photo-alignment film was 0.2 μm.

Subsequently, the composition (1-3) for forming an optically anisotropic layer described in Example 1 was applied onto the photo-alignment film using a geeser coating machine while continuously transporting the elongated film without being wound up and heated with hot air at 80° C. for 60 seconds. Subsequently, the obtained composition layer was irradiated with UV (500 mJ/cm²) at 80° C. to immobilize the alignment of the liquid crystal compound to form an optically anisotropic layer (5-3) corresponding to the third optically anisotropic layer.

The optically anisotropic layer (5-3) had a thickness of 1.25 And of 170 nm at a wavelength of 550 nm, and a twisted angle of a liquid crystal compound of 85°. Assuming that the width direction of the film is defined as 0° (the longitudinal direction of the film is defined as 90°), the in-plane slow axis direction (alignment axis angle of the liquid crystal compound) was 10° on the air side and 95° on the side in contact with the optically anisotropic layer (1-4), in a case of viewing from the optically anisotropic layer (5-3) side.

The in-plane slow axis direction of the optically anisotropic layer is expressed as negative in a case where it is clockwise (right-handed turning) and positive in a case where it is counterclockwise (left-handed turning) with the width direction of the substrate as a reference of 0°, upon observing the substrate from the surface side of the optically anisotropic layer.

A laminated film (5B) having the optically anisotropic layer (1-4), the photo-alignment film, and the optically anisotropic layer (5-3) laminated in this order on an elongated cellulose acylate film and wound into a roll was obtained by the above procedure.

A laminated film (5) and a circularly polarizing plate (P5) were prepared in the same manner as in Example 1, except that the laminated film (5B) was used instead of the laminated film (1B).

### Example 6

Subsequently, while transporting the roll-shaped laminated film (1A) prepared by the method of Example 1, the surface of the optically anisotropic layer (1-2) was subjected to a corona treatment, and the composition (4) for forming a photo-alignment film described in Example 4 was applied using a geeser coating machine and dried at 80° C. for 1 minute. Then, the obtained coating film was irradiated with UV light (ultra-high pressure mercury lamp; UL750, manufactured by HOYA Corporation) passing through a wire grid polarizer at an irradiation dose of 10 mJ/cm² (wavelength: 313 nm) to form a photo-alignment film on the surface of the optically anisotropic layer (1-2).

The film thickness of the formed photo-alignment film was 0.2 μm.

Subsequently, the composition (1-3) for forming an optically anisotropic layer described in Example 1 was applied onto the photo-alignment film using a geeser coating machine while continuously transporting the elongated film without being wound up and heated with hot air at 80° C. for 60 seconds. Subsequently, the obtained composition layer was irradiated with UV (500 mJ/cm²) at 80° C. to immobilize the alignment of the liquid crystal compound to form an optically anisotropic layer (6-3) corresponding to the third optically anisotropic layer.

The optically anisotropic layer (6-3) had a thickness of 1.25 And of 170 nm at a wavelength of 550 nm, and a twisted angle of a liquid crystal compound of 85°. Assuming that the width direction of the film is defined as 0° (the longitudinal direction of the film is defined as 90°), the in-plane slow axis direction (alignment axis angle of the liquid crystal compound) was −95° on the air side and −10° on the side in contact with the optically anisotropic layer (1-2), in a case of viewing from the optically anisotropic layer (6-3) side. The in-plane slow axis on the surface side of the optically anisotropic layer (6-3) is −4° with respect to the in-plane slow axis on the surface side of the optically anisotropic layer (1-2).

A laminated film (6A) having the optically anisotropic layer (1-1), the optically anisotropic layer (1-2), and the optically anisotropic layer (6-3) laminated in this order on an elongated cellulose acylate film and wound into a roll was obtained by the above procedure.

A laminated film (6) and a circularly polarizing plate (P6) were prepared in the same manner as in Example 1, except that the laminated film (6A) was used instead of the laminated film (1A), and the laminated film (1B-1) prepared by the method of Example 5 was used instead of the laminated film (1B).

The optically anisotropic layer (6-3) and the optically anisotropic layer (1-4) adjacent to the adhesive layer had refractive indices of 1.57 and 1.57, respectively. The difference in refractive index between the adjacent optically anisotropic layer and the adhesive layer was 0.05 or less.

### Example 7

Subsequently, while transporting the roll-shaped laminated film (1B) prepared by the method of Example 1, the surface of the optically anisotropic layer (1-3) was subjected to a corona treatment, and the composition (4) for forming a photo-alignment film described in Example 4 was applied using a geeser coating machine and dried at 80° C. for 1 minute. Then, the obtained coating film was irradiated with UV light (ultra-high pressure mercury lamp; UL750, manufactured by HOYA Corporation) passing through a wire grid polarizer at an irradiation dose of 10 mJ/cm² (wavelength: 313 nm) to form a photo-alignment film on the surface of the optically anisotropic layer (1-3).

The film thickness of the formed photo-alignment film was 0.2 μm.

Subsequently, the composition (1-2) for forming an optically anisotropic layer described in Example 1 was applied onto the photo-alignment film provided on the laminated film (1B) using a geeser coating machine while continuously transporting the elongated film without being wound up and heated with hot air at 80° C. for 60 seconds. Subsequently, the obtained composition layer was irradiated with UV (500 mJ/cm²) at 80° C. to immobilize the alignment of the liquid crystal compound to form an optically anisotropic layer (7-2) corresponding to the second optically anisotropic layer.

The optically anisotropic layer (7-2) had a thickness of 1.5 μm and an in-plane retardation of 153 nm at a wavelength of 550 nm. It was confirmed that the average tilt angle of the disc plane of the disk-like liquid crystal compound with respect to the film surface was 90°, and the disk-like liquid crystal compound was aligned perpendicular to the film surface.

Assuming that the width direction of the film is defined as 0° (the counterclockwise direction is defined as 90° and the clockwise direction is defined as −90° in a longitudinal direction), the in-plane slow axis direction of the optically anisotropic layer (7-2) was +14° in a case of viewing from the optically anisotropic layer (7-2) side.

A laminated film (7B) having the optically anisotropic layer (1-4), the optically anisotropic layer (1-3), and the optically anisotropic layer (7-2) laminated in this order on an elongated cellulose acylate film and wound into a roll was obtained by the above procedure.

A laminated film (7) and a circularly polarizing plate (P7) were prepared in the same manner as in Example 1, except that the laminated film (1A-1) prepared by the method of Example 4 was used instead of the laminated film (1A), and the laminated film (7B) was used instead of the laminated film (1B).

The optically anisotropic layer (1-1) and the optically anisotropic layer (7-2) adjacent to the adhesive layer had refractive indices of 1.60 and 1.59, respectively. The difference in refractive index between the adjacent optically anisotropic layer and the adhesive layer was 0.05 or less.

### Example 8

Formation of Laminated Film (8A)

A composition (8-1) for forming an optically anisotropic layer containing a rod-like liquid crystal compound having the following composition was applied onto an elongated cellulose acetate film ZRG20 (manufactured by FUJIFILM Corporation, thickness: 20 μm) using a geeser coating machine to form a composition layer. The film on which the composition layer was formed was heated with hot air at 116° C. for 1 minute, and irradiated with ultraviolet rays at an irradiation dose of 150 mJ/cm² using a 365 nm UV-LED while purging with nitrogen to achieve an atmosphere with an oxygen concentration of 100 ppm by volume or less at a UV temperature of 78° C. Then, the obtained coating film was annealed with hot air at 115° C. for 25 seconds to form an optically anisotropic layer (8-1) corresponding to the first optically anisotropic layer.

The obtained optically anisotropic layer (8-1) was irradiated with UV light (ultra-high pressure mercury lamp; UL750, manufactured by HOYA Corporation) passing through a wire grid polarizer at room temperature at 7.9 mJ/cm² (wavelength: 313 nm) to form a composition layer having an alignment control ability on the surface.

The film thickness of the formed optically anisotropic layer (8-1) was 0.9 The in-plane retardation Re at a wavelength of 550 nm was 0 nm, and the thickness direction retardation Rth at a wavelength of 550 nm was 40 nm. It was confirmed that the average tilt angle of the disc plane of the disk-like liquid crystal compound with respect to the film surface was 0°, and the disk-like liquid crystal compound was horizontally aligned with respect to the film surface.

Composition (8-1) for forming optically anisotropic layer

| | |
|---|---|
| Disk-like liquid crystal compound 1 given above | 4 parts by mass |
| Disk-like liquid crystal compound 2 given above | 1 parts by mass |
| Disk-like liquid crystal compound 3 given above | 95.0 parts by mass |
| Polymerizable monomer 1 given above | 12.0 parts by mass |
| Polymerization initiator S-1 (oxime type) given above | 3.0 parts by mass |
| Photoacid generator D-1 given above | 3.0 parts by mass |
| Photo-alignable polymer A-1 given above | 0.6 parts by mass |
| Diisopropylethylamine | 0.2 parts by mass |
| Methyl isobutyl ketone | 380 parts by mass |
| Ethyl propionate | 95 parts by mass |

The composition (1-2) for forming an optically anisotropic layer described in Example 1 was applied onto the optically anisotropic layer (8-1) using a geeser coating machine while continuously transporting the elongated film without being wound up and heated with hot air at 95° C. for 120 seconds. Subsequently, the obtained composition layer was irradiated with UV (100 mJ/cm²) at 95° C. to immobilize the alignment of the liquid crystal compound to form an optically anisotropic layer (8-2) corresponding to the second optically anisotropic layer.

The optically anisotropic layer (8-2) had a thickness of 1.5 μm and an in-plane retardation of 153 nm at a wavelength of 550 nm. It was confirmed that the average tilt angle of the disc plane of the disk-like liquid crystal compound with respect to the film surface was 90°, and the disk-like liquid crystal compound was aligned perpendicular to the film surface.

Assuming that the width direction of the film is defined as 0° (the counterclockwise direction is defined as 90° and the clockwise direction is defined as −90° in a longitudinal direction), the in-plane slow axis direction of the optically anisotropic layer (8-2) was −14° in a case of viewing from the optically anisotropic layer (8-2) side.

A laminated film (8A) having the optically anisotropic layer (8-1) and the optically anisotropic layer (8-2) directly laminated on an elongated cellulose acylate film ZRG20 and wound into a roll was obtained by the above procedure.

Preparation of Laminated Film (8)

The liquid crystal-coated surface side of the above-prepared laminated film (8A) consisting of an elongated cellulose acylate film and the liquid crystal-coated surface side of the laminated film (1B) described in Example 1 were continuously bonded to each other using the ultraviolet curable adhesive composition (1) so that the longitudinal directions of the films were parallel to each other. The in-plane slow axis on the surface side of the optically anisotropic layer (1-3) of the laminated film (1B) is +4° with respect to the in-plane slow axis on the surface side of the optically anisotropic layer (8-2) of the laminated film (8A).

In this manner, an elongated laminated film (8) in which the cellulose acylate film ZRG20, the optically anisotropic layer (8-1), the optically anisotropic layer (8-2), the adhesive layer, the optically anisotropic layer (1-3), and the optically anisotropic layer (1-4) were laminated in this order was obtained.

Preparation of Circularly Polarizing Plate (P8)

The surface of the cellulose acylate film ZRG20 of the above prepared elongated laminated film (8) and the surface of the polarizer (the surface opposite to the polarizer protective film) of the elongated linearly polarizing plate described in Example 1 were continuously bonded to each other using a pressure sensitive adhesive OPTERIA NCF-D692 (5 manufactured by Lintec Corporation). Subsequently, the cellulose acylate film on the optically anisotropic layer (1-4) side was peeled off to expose the surface of the optically anisotropic layer (1-4) in contact with the cellulose acylate film.

In this manner, a circularly polarizing plate (P8) consisting of the laminated film (8) and the linearly polarizing plate was prepared. At this time, the polarizer protective film, the PVA adhesive, the polarizer, the pressure sensitive adhesive, the cellulose acylate film ZRG20, the optically anisotropic layer (8-1), the optically anisotropic layer (8-2), the adhesive layer, the optically anisotropic layer (1-3), and the optically anisotropic layer (1-4) were laminated in this order, and the angle formed by the absorption axis of the polarizer and the in-plane slow axis of the optically anisotropic layer (8-2) was 76°. In addition, the in-plane slow axis direction on the surface of the optically anisotropic layer (1-3) on the optically anisotropic layer (8-2) side was 14°, with the width direction as a reference of 0°. The angle formed by the in-plane slow axis direction of the optically anisotropic layer (1-3) and the in-plane slow axis direction of the optically anisotropic layer (8-2) was 4°. In addition, the in-plane slow axis direction on the surface of the optically anisotropic layer (1-3) on the optically anisotropic layer (1-4) side was 95°, with the width direction as a reference of 0°.

### Example 9

Formation of Laminated Film (9A)

The composition (1-1) for forming an optically anisotropic layer described in Example 1 was applied onto the cellulose acylate film described in Example 1 using a geeser coating machine to form a composition layer. The film on which the composition layer was formed was heated with hot air at 116° C. for 1 minute, and irradiated with ultraviolet rays at an irradiation dose of 150 mJ/cm² using a 365 nm UV-LED while purging with nitrogen to achieve an atmosphere with an oxygen concentration of 100 ppm by volume or less at a UV temperature of 78° C. Then, the obtained coating film was annealed with hot air at 115° C. for 25 seconds to form an optically anisotropic layer (9-1) corresponding to the first optically anisotropic layer.

The obtained optically anisotropic layer (9-1) was irradiated with UV light (ultra-high pressure mercury lamp; UL750, manufactured by HOYA Corporation) passing through a wire grid polarizer at room temperature at 7.9 mJ/cm² (wavelength: 313 nm) to form a composition layer having an alignment control ability on the surface.

The film thickness of the formed optically anisotropic layer (9-1) was 0.7 The in-plane retardation Re at a wavelength of 550 nm was 0 nm, and the thickness direction retardation Rth at a wavelength of 550 nm was 30 nm. It was confirmed that the average tilt angle of the disc plane of the disk-like liquid crystal compound with respect to the film surface was 0°, and the disk-like liquid crystal compound was horizontally aligned with respect to the film surface.

The composition (1-2) for forming an optically anisotropic layer described in Example 1 was applied onto the optically anisotropic layer (9-1) using a geeser coating machine while continuously transporting the elongated film without being wound up and heated with hot air at 95° C. for 120 seconds. Subsequently, the obtained composition layer was irradiated with UV (100 mJ/cm²) at 95° C. to immobilize the alignment of the liquid crystal compound to form an optically anisotropic layer (9-2) corresponding to the second optically anisotropic layer.

The optically anisotropic layer (9-2) had a thickness of 1.5 μm and an in-plane retardation of 153 nm at a wavelength of 550 nm. It was confirmed that the average tilt angle of the disc plane of the disk-like liquid crystal compound with respect to the film surface was 90°, and the disk-like liquid crystal compound was aligned perpendicular to the film surface.

Assuming that the width direction of the film is defined as 0° (the counterclockwise direction is defined as 90° and the clockwise direction is defined as −90° in a longitudinal direction), the in-plane slow axis direction of the optically anisotropic layer (9-2) was −14° in a case of viewing from the optically anisotropic layer (9-2) side.

A laminated film (9A) having the optically anisotropic layer (9-1) and the optically anisotropic layer (9-2) directly laminated on an elongated cellulose acylate film and wound into a roll was obtained by the above procedure.

Formation of Laminated Film (9B)

A composition (1-4) for forming an optically anisotropic layer containing a rod-like liquid crystal compound having the following composition was applied onto the cellulose acylate film described in Example 1 using a geeser coating machine to form a composition layer. The film on which the composition layer was formed was heated with hot air at 60° C. for 1 minute, and irradiated with ultraviolet rays at an irradiation dose of 100 mJ/cm² using a 365 nm UV-LED while purging with nitrogen to achieve an atmosphere with an oxygen concentration of 100 ppm by volume or less. Then, the obtained coating film was annealed with hot air at 120° C. for 1 minute to form an optically anisotropic layer (9-5) corresponding to the fifth optically anisotropic layer.

While continuously transporting the elongated film without being wound up, the optically anisotropic layer (9-5) was irradiated with UV light (ultra-high pressure mercury lamp; UL750, manufactured by HOYA Corporation) passing through a wire grid polarizer at 7.9 mJ/cm² (wavelength: 313 nm) to form a composition layer having an alignment control ability on the surface.

The film thickness of the formed optically anisotropic layer (9-5) was 0.7 The in-plane retardation Re at a wavelength of 550 nm was 0 nm, and the thickness direction retardation Rth at a wavelength of 550 nm was −90 nm. It was confirmed that the average tilt angle of the major axis direction of the rod-like liquid crystal compound with respect to the film surface was 90° and the rod-like liquid crystal compound was aligned perpendicular to the film surface.

The composition (1-3) for forming an optically anisotropic layer described in Example 1 was applied onto the optically anisotropic layer (9-5) using a geeser coating machine while continuously transporting the elongated film without being wound up and heated with hot air at 80° C. for 60 seconds. Subsequently, the obtained composition layer was irradiated with UV (500 mJ/cm²) at 80° C. to immobilize the alignment of the liquid crystal compound to form an optically anisotropic layer (9-4) corresponding to the fourth optically anisotropic layer.

The optically anisotropic layer (9-4) had a thickness of 1.25 And of 170 nm at a wavelength of 550 nm, and a twisted angle of a liquid crystal compound of 85°. Assuming that the width direction of the film is defined as 0° (the longitudinal direction of the film is defined as 90°), the in-plane slow axis direction (alignment axis angle of the liquid crystal compound) was 10° on the air side and 95° on the side in contact with the optically anisotropic layer (9-5), in a case of viewing from the optically anisotropic layer (9-4) side.

The in-plane slow axis direction of the optically anisotropic layer is expressed as negative in a case where it is clockwise (right-handed turning) and positive in a case where it is counterclockwise (left-handed turning) with the width direction of the substrate as a reference of 0°, upon observing the substrate from the surface side of the optically anisotropic layer.

The elongated film was wound into a roll and then fed out again, and a corona treatment was carried out on the optically anisotropic layer (9-4). Then, the following composition (9-3) for forming an optically anisotropic layer was applied using a geeser coating machine and heated with hot air at 80° C. for 60 seconds. Subsequently, the obtained composition layer was irradiated with UV (500 mJ/cm²) at 80° C. to immobilize the alignment of the liquid crystal compound to form an optically anisotropic layer (9-3) corresponding to the third optically anisotropic layer.

Composition (9-3) for forming optically anisotropic layer

| | |
|---|---|
| Rod-like liquid crystal compound (A) | 20.0 parts by mass |
| given above | |
| Polymerizable monomer | 4.2 parts by mass |
| (A-400, manufactured by Shin-Nakamura | |
| Chemical Co., Ltd.) | |
| Polymerization initiator S-1 (oxime type) | 5.1 parts by mass |
| given above | |
| Photoacid generator D-1 given above | 3.0 parts by mass |
| Polymer M-1 given above | 2.0 parts by mass |
| Vertical alignment agent S01 given above | 2.0 parts by mass |
| Fluorine-containing compound A given above | 0.4 parts by mass |
| Diisopropylethylamine | 2.0 parts by mass |
| Methyl ethyl ketone | 42.3 parts by mass |
| Methyl isobutyl ketone | 627.5 parts by mass |

The film thickness of the formed optically anisotropic layer (9-3) was 0.05 μm. The in-plane retardation Re at a wavelength of 550 nm was 0 nm, and the thickness direction retardation Rth at a wavelength of 550 nm was −5 nm. It was confirmed that the average tilt angle of the major axis direction of the rod-like liquid crystal compound with respect to the film surface was 90° and the rod-like liquid crystal compound was aligned perpendicular to the film surface.

A laminated film (9B) having the optically anisotropic layer (9-5), the optically anisotropic layer (9-4), and the optically anisotropic layer (9-3) directly laminated on an elongated cellulose acylate film and wound into a roll was obtained by the above procedure.

Preparation of Laminated Film (9)

An elongated laminated film (9) having the optically anisotropic layer (9-1), the optically anisotropic layer (9-2), the optically anisotropic layer (9-3), the optically anisotropic layer (9-4), and the optically anisotropic layer (9-5) laminated in this order was obtained in the same manner as in Example 1, except that the laminated film (9A) and the laminated film (9B) were used instead of the laminated film (1A) and the laminated film (1B).

Preparation of Circularly Polarizing Plate (P9)

The surface of the optically anisotropic layer (9-1) of the above prepared elongated laminated film (9) and the surface of the polarizer (the surface opposite to the polarizer protective film) of the above prepared elongated linearly polarizing plate were continuously bonded to each other using a pressure sensitive adhesive OPTERIA NCF-D692 (5 manufactured by Lintec Corporation). Subsequently, the cellulose acylate film on the optically anisotropic layer (9-5) side was peeled off to expose the surface of the optically anisotropic layer (9-5) in contact with the cellulose acylate film.

In this manner, a circularly polarizing plate (P9) consisting of the laminated film (9) and the linearly polarizing plate was prepared. At this time, the polarizer protective film, the polarizer, the optically anisotropic layer (9-1), the optically anisotropic layer (9-2), the optically anisotropic layer (9-3), the optically anisotropic layer (9-4), and the optically anisotropic layer (9-5) were laminated in this order, and the angle formed by the absorption axis of the polarizer and the in-plane slow axis of the optically anisotropic layer (9-2) was 76°. In addition, the in-plane slow axis direction on the surface of the optically anisotropic layer (9-4) on the optically anisotropic layer (9-3) side was 10°, with the width direction as a reference of 0°. The angle formed by the in-plane slow axis direction of the optically anisotropic layer (9-4) and the in-plane slow axis direction of the optically anisotropic layer (9-2) was 4°. In addition, the in-plane slow axis direction on the surface of the optically anisotropic layer (9-4) on the optically anisotropic layer (9-5) side was 95°, with the width direction as a reference of 0°.

### Example 10

Preparation of Laminated Film (10A)

The composition (1-4) for forming an optically anisotropic layer described in Example 1 was applied onto the cellulose acylate film prepared in Example 1 using a geeser coating machine to form a composition layer. The obtained film was heated with hot air at 60° C. for 1 minute, and irradiated with ultraviolet rays having an irradiation amount of 100 mJ/cm² using a 365 nm UV-LED while purging with nitrogen so as to have an atmosphere having an oxygen concentration of 100 ppm by volume or less. Then, the obtained coating film was annealed with hot air at 120° C. for 1 minute to form an optically anisotropic layer (10-1) corresponding to the first optically anisotropic layer.

The obtained optically anisotropic layer (10-1) was irradiated with UV light (ultra-high pressure mercury lamp; UL750, manufactured by HOYA Corporation) passing through a wire grid polarizer at room temperature at 7.9 mJ/cm² (wavelength: 313 nm) to form a composition layer having an alignment control ability on the surface.

The film thickness of the formed optically anisotropic layer (10-1) was 0.49 μm. The in-plane retardation Re at a wavelength of 550 nm was 0 nm, and the thickness direction retardation Rth at a wavelength of 550 nm was −55 nm. It was confirmed that the average tilt angle of the major axis direction of the rod-like liquid crystal compound with respect to the film surface was 90° and the rod-like liquid crystal compound was aligned perpendicular to the film surface.

Next, a composition (10-2) for forming an optically anisotropic layer containing a rod-like liquid crystal compound having the following composition was applied onto the optically anisotropic layer (10-1) prepared above by using a geeser coating machine, and heated with hot air at 80° C. for 60 seconds. Subsequently, the obtained composition layer was irradiated with UV (500 mJ/cm²) at 80° C. to immobilize the alignment of the liquid crystal compound to form an optically anisotropic layer (10-2) corresponding to the second optically anisotropic layer.

The optically anisotropic layer (10-2) had a thickness of 0.53 μm and an in-plane retardation Re (550) of 75 nm at a wavelength of 550 nm. Assuming that the width direction of the film is defined as 0° (the longitudinal direction of the film is defined as 90°), the in-plane slow axis direction (alignment axis angle of the liquid crystal compound) was 90°.

Composition (10-2) for forming optically anisotropic layer

| | |
|---|---|
| Rod-like liquid crystal compound (A) given above | 100 parts by mass |
| Ethylene oxide-modified trimethylolpropane triacrylate | 4 parts by mass |
| (V# 360, manufactured by Osaka Organic Chemical | |
| Industry Ltd.) | |
| Photopolymerization initiator | 3 parts by mass |
| (IRGACURE 819, manufactured by BASF SE) | |
| Fluorine-containing compound C given above | 0.08 parts by mass |
| Methyl ethyl ketone | 156 parts by mass |

A laminated film (10A) in which the optically anisotropic layer (10-1) and the optically anisotropic layer (10-2) were directly laminated on an elongated cellulose acylate film was prepared by the above procedure.

Preparation of Laminated Film (10B)

The composition (1-4) for forming an optically anisotropic layer described in Example 1 was applied onto the cellulose acylate film prepared in Example 1 using a geeser coating machine to form a composition layer. The obtained film was heated with hot air at 60° C. for 1 minute, and irradiated with ultraviolet rays having an irradiation amount of 100 mJ/cm² using a 365 nm UV-LED while purging with nitrogen so as to have an atmosphere having an oxygen concentration of 100 ppm by volume or less. Then, the obtained coating film was annealed with hot air at 120° C. for 1 minute to form an optically anisotropic layer (10-4) corresponding to the fourth optically anisotropic layer.

The obtained optically anisotropic layer (10-4) was irradiated with UV light (ultra-high pressure mercury lamp; UL750, manufactured by HOYA Corporation) passing through a wire grid polarizer at room temperature at 7.9 mJ/cm² (wavelength: 313 nm) to form a composition layer having an alignment control ability on the surface.

The film thickness of the formed optically anisotropic layer (10-4) was 0.35 The in-plane retardation Re at a wavelength of 550 nm was 0 nm, and the thickness direction retardation Rth at a wavelength of 550 nm was −40 nm. It was confirmed that the average tilt angle of the major axis direction of the rod-like liquid crystal compound with respect to the film surface was 90° and the rod-like liquid crystal compound was aligned perpendicular to the film surface.

Next, a composition (10-3) for forming an optically anisotropic layer containing a rod-like liquid crystal compound having the following composition was applied onto the optically anisotropic layer (10-4) prepared above using a geeser coating machine, once heated to 120° C. with hot air, and then cooled to 60° C. to stabilize the alignment. Then, using an ultra-high pressure mercury lamp and in a nitrogen atmosphere (oxygen concentration of less than 100 ppm), the film temperature was kept at 60° C., the first UV irradiation (80 mJ/cm²) was carried out, the film temperature was kept at 100° C., and then the second UV irradiation (300 mJ/cm²) was carried out to immobilize the alignment to form an optically anisotropic layer (10-3) corresponding to the third optically anisotropic layer.

The optically anisotropic layer (10-3) had a thickness of 2.8 μm and an Re (550) of 141 nm at a wavelength of 550 nm. Assuming that the width direction of the film is defined as 0° (the longitudinal direction of the film is defined as 90°), the in-plane slow axis direction (alignment axis angle of the liquid crystal compound) was 45°.

Composition (10-3) for forming optically anisotropic layer

| | |
|---|---|
| Rod-like liquidcrystal compound (B) given below | 21.2 parts by mass |
| Rod-like liquidcrystal compound (C) given below | 26.1 parts by mass |
| Rod-like liquidcrystal compound (D) given below | 29.0 parts by mass |
| Rod-like liquidcrystal compound (E) given below | 8.5 parts by mass |
| Compound (1) given below | 15.3 parts by mass |
| Polymerization initiator S-1 (oxime type) given | 0.5 parts by mass |
| above | |
| Fluorine-containing compound D given below | 0.1 parts by mass |
| Cyclopentanone | 175.0 parts by mass |
| Methyl ethyl ketone | 50.0 parts by mass |
| Ethyl laurate | 10.0 parts by mass |

Rod-Like Liquid Crystal Compound (B)

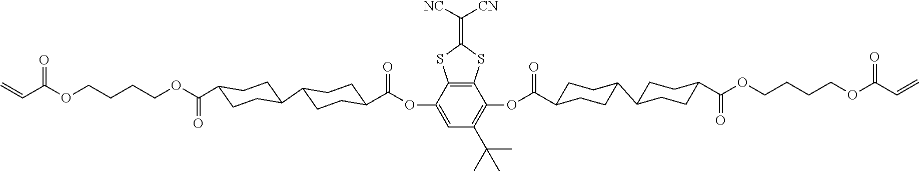 [SMILES: C=CC(=O)OCCCCOC(=O)C1CCC(C2CCC(C(=O)Oc3cc(C(C)(C)C)c(OC(=O)C4CCC(C5CCC(C(=O)OCCCCOC(=O)C=C)CC5)CC4)c4c3SC(=C(C#N)C#N)S4)CC2)CC1]

Rod-Like Liquid Crystal Compound (C)

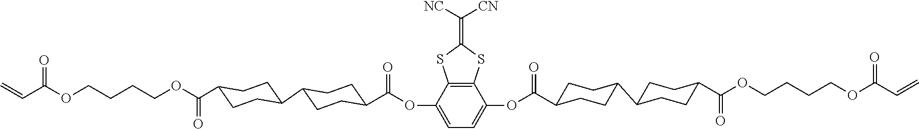 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c4c3SC(=C(C#N)C#N)S4)CC2)CC1]

Rod-Like Liquid Crystal Compound (D)

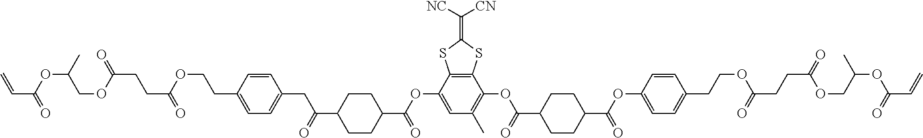 [SMILES: C=CC(=O)OC(C)COC(=O)CCC(=O)OCCc1ccc(CC(=O)C2CCC(C(=O)Oc3cc(C)c(OC(=O)C4CCC(C(=O)Oc5ccc(CCOC(=O)CCC(=O)OCC(C)OC(=O)C=C)cc5)CC4)c4c3SC(=C(C#N)C#N)S4)CC2)cc1]

Rod-Like Liquid Crystal Compound (E)

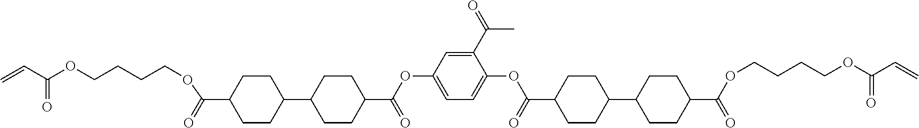 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c(C(C)=O)c3)CC2)CC1]

Compound (1)

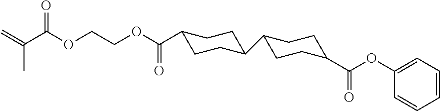 [SMILES: C=C(C)C(=O)OCCOC(=O)C1CCC(C2CCC(C(=O)Oc3ccccc3)CC2)CC1]

Fluorine-Containing Compound D

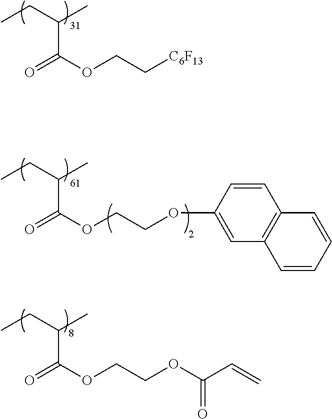

A laminated film (10B) in which the optically anisotropic layer (10-4) and the optically anisotropic layer (10-3) were directly laminated on an elongated cellulose acylate film was prepared by the above procedure.

A laminated film (10) and a circularly polarizing plate (P10) were prepared in the same manner as in Example 1, except that the laminated film (10A) was used instead of the laminated film (1A), and the laminated film (10B) was used instead of the laminated film (1B).

### Comparative Example 1

Preparation of Laminated Film (C1A)

A composition (C1-1) for forming an optically anisotropic layer containing a rod-like liquid crystal compound having the following composition was applied onto the cellulose acylate film described in Example 1 using a geeser coating machine to form a composition layer. The film on which the composition layer was formed was heated with hot air at 116° C. for 1 minute. While purging with nitrogen to achieve an atmosphere with an oxygen concentration of 100 ppm by volume or less at a UV temperature of 78° C., UV irradiation (500 mJ/cm²) was carried out to immobilize the alignment of the liquid crystal compound to form an optically anisotropic layer (C1-1) corresponding to the first optically anisotropic layer.

The film thickness of the formed optically anisotropic layer (C1-1) was 0.9 The in-plane retardation Re at a wavelength of 550 nm was 0 nm, and the thickness direction retardation Rth at a wavelength of 550 nm was 40 nm. It was confirmed that the average tilt angle of the disc plane of the disk-like liquid crystal compound with respect to the film surface was 0°, and the disk-like liquid crystal compound was horizontally aligned with respect to the film surface.

Composition (C1-1) for forming optically anisotropic layer

| | |
|---|---|
| Disk-like liquid crystal compound 1 given above | 4 parts by mass |
| Disk-like liquid crystal compound 2 given above | 1 parts by mass |
| Disk-like liquid crystal compound 3 given above | 95.0 parts by mass |
| Polymerizable monomer 1 given above | 12.0 parts by mass |
| Polymerization initiator S-1 (oxime type) given above | 3.0 parts by mass |
| Photoacid generator D-1 given above | 3.0 parts by mass |
| Fluorine-containing compound E given above | 0.6 parts by mass |
| Diisopropylethylamine | 0.2 parts by mass |
| o-Xylene | 475 parts by mass |

A laminated film (C1A) having the optically anisotropic layer (C1-1) laminated on an elongated cellulose acylate film and wound into a roll was obtained by the above procedure.

Preparation of Alignment Film (10)

The following composition (10) for forming an alignment film was applied onto the cellulose acylate film described in Example 1 using a geeser coating machine to form a photo-alignment film. The cellulose acylate film on which the photo-alignment film was formed was dried with hot air at 140° C. for 120 seconds, and then irradiated with polarized ultraviolet rays (10 mJ/cm², using an ultra-high pressure mercury lamp) to form an alignment film (10).

Composition (10) for forming alignment film

| | |
|---|---|
| Photo-alignable polymer A-4 given below | 100.00 parts by mass |
| Isopropyl alcohol | 16.50 parts by mass |
| Butyl acetate | 1072.00 parts by mass |
| Methyl ethyl ketone | 268.00 parts by mass |

Photo-Alignable Polymer A-4

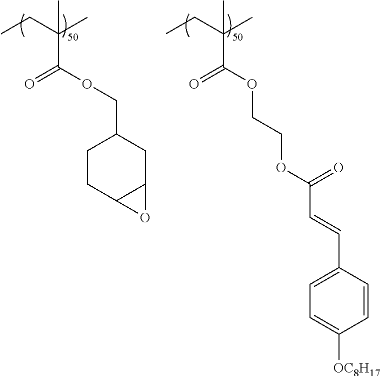

Preparation of Laminated Film (C1B)

The composition (1-2) for forming an optically anisotropic layer described in Example 1 was applied onto the alignment film using a geeser coating machine while continuously transporting the elongated film having the alignment film (10) without being wound up and heated with hot air at 95° C. for 120 seconds. Subsequently, the obtained composition layer was irradiated with UV (100 mJ/cm²) at 95° C. to immobilize the alignment of the liquid crystal compound to form an optically anisotropic layer (C1-2) corresponding to the second optically anisotropic layer.

The optically anisotropic layer (C1-2) had a thickness of 1.5 μm and an in-plane retardation of 153 nm at a wavelength of 550 nm. It was confirmed that the average tilt angle of the disc plane of the disk-like liquid crystal compound with respect to the film surface was 90°, and the disk-like liquid crystal compound was aligned perpendicular to the film surface.

Assuming that the width direction of the film is defined as 0° (the counterclockwise direction is defined as 90° and the clockwise direction is defined as −90° in a longitudinal direction), the in-plane slow axis direction of the optically anisotropic layer (C1-2) was +14° in a case of viewing from the optically anisotropic layer (C1-2) side.

A laminated film (C1B) having the alignment film (10) and the optically anisotropic layer (C1-2) laminated on an elongated cellulose acylate film and wound into a roll was obtained by the above procedure.

Preparation of Laminated Film (C1C)

The composition (1-3) for forming an optically anisotropic layer described in Example 1 was applied onto the alignment film using a geeser coating machine while continuously transporting the elongated film having the alignment film (10) without being wound up and heated with hot air at 80° C. for 60 seconds. Subsequently, the obtained composition layer was irradiated with UV (500 mJ/cm²) at 80° C. to immobilize the alignment of the liquid crystal compound to form an optically anisotropic layer (C1-3) corresponding to the third optically anisotropic layer.

The optically anisotropic layer (C1-3) had a thickness of 1.25 And of 170 nm at a wavelength of 550 nm, and a twisted angle of a liquid crystal compound of 85°. Assuming that the width direction of the film is defined as 0° (the longitudinal direction of the film is defined as 90°), the in-plane slow axis direction (alignment axis angle of the liquid crystal compound) was 10° on the air side and 95° on the side in contact with the alignment film (10), in a case of viewing from the optically anisotropic layer (C1-3) side.

The in-plane slow axis direction of the optically anisotropic layer is expressed as negative in a case where it is clockwise (right-handed turning) and positive in a case where it is counterclockwise (left-handed turning) with the width direction of the substrate as a reference of 0°, upon observing the substrate from the surface side of the optically anisotropic layer.

A roll-shaped laminated film (C1C) in which the alignment film (10) and the optically anisotropic layer (C1-3) were laminated on an elongated cellulose acylate film was prepared by the above procedure.

Preparation of Laminated Film (C1D)

A composition (C1-4) for forming an optically anisotropic layer containing a rod-like liquid crystal compound having the following composition was applied onto the cellulose acylate film described in Example 1 using a geeser coating machine to form a composition layer. The film on which the composition layer was formed was heated with hot air at 60° C. for 1 minute. While purging with nitrogen to achieve an atmosphere with an oxygen concentration of 100 ppm by volume or less, UV irradiation (500 mJ/cm²) was carried out to immobilize the alignment of the liquid crystal compound to form an optically anisotropic layer (C1-4) corresponding to the fourth optically anisotropic layer.

The film thickness of the formed optically anisotropic layer (C1-4) was 0.7 The in-plane retardation Re at a wavelength of 550 nm was 0 nm, and the thickness direction retardation Rth at a wavelength of 550 nm was −85 nm. It was confirmed that the average tilt angle of the major axis direction of the rod-like liquid crystal compound with respect to the film surface was 90° and the rod-like liquid crystal compound was aligned perpendicular to the film surface.

Composition (C1-4) for forming optically anisotropic layer

| | |
|---|---|
| Rod-like liquid crystal compound (A) | 100 parts by mass |
| given above | |
| Polymerizable monomer | 4.2 parts by mass |
| (A-400, manufactured by Shin-Nakamura | |
| Chemical Co., Ltd.) | |
| Polymerization initiator S-1 (oxime type) | 5.1 parts by mass |
| given above | |
| Photoacid generator D-1 given above | 3.0 parts by mass |
| Polymer M-1 given above | 2.0 parts by mass |
| Vertical alignment agent S01 given above | 2.0 parts by mass |
| Fluorine-containing compound A given above | 0.4 parts by mass |
| Diisopropylethylamine | 2.0 parts by mass |
| Methyl ethyl ketone | 42.3 parts by mass |
| Methyl isobutyl ketone | 627.5 parts by mass |

A laminated film (C1D) having the optically anisotropic layer (C1-4) laminated on an elongated cellulose acylate film and wound into a roll was obtained by the above procedure.

Preparation of Laminated Film (C1)

The liquid crystal-coated surface side of the above-prepared laminated film (C1A) consisting of an elongated cellulose acylate film and the liquid crystal-coated surface side of the above-prepared laminated film (C1B) formed on an elongated cellulose acylate film were continuously bonded to each other using a pressure sensitive adhesive OPTERIA NCF-D692 (5 manufactured by Lintec Corporation) so that the longitudinal directions of the films were parallel to each other. Subsequently, the cellulose acylate film on the laminated film (C1B) side was peeled off to expose the surface of the optically anisotropic layer (C1-2) in contact with the cellulose acylate film. In this manner, an elongated laminated film (C1AB) in which the optically anisotropic layer (C1-1), the pressure sensitive adhesive layer, and the optically anisotropic layer (C1-2) were laminated in this order on a cellulose acylate film was obtained. Assuming that the width direction of the film is defined as 0° (the counterclockwise direction is defined as 90° and the clockwise direction is defined as −90° in a longitudinal direction), the in-plane slow axis direction of the optically anisotropic layer (C1-2) was −14° in a case of viewing from the optically anisotropic layer (C1-2) side.

Subsequently, the liquid crystal-coated surface side of the optically anisotropic layer (C1-2) of the laminated film (C1AB) and the liquid crystal-coated surface side of the above-prepared laminated film (C1C) were continuously bonded to each other using a pressure sensitive adhesive OPTERIA NCF-D692 (5 manufactured by Lintec Corporation) so that the longitudinal directions of the films were parallel to each other. Subsequently, the cellulose acylate film on the laminated film (C1C) side was peeled off to expose the surface of the optically anisotropic layer (C1-3) in contact with the cellulose acylate film. In this manner, an elongated laminated film (C1ABC) in which the optically anisotropic layer (C1-1), the pressure sensitive adhesive layer, the optically anisotropic layer (C1-2), the pressure sensitive adhesive layer, and the optically anisotropic layer (C1-3) were laminated in this order on a cellulose acylate film was obtained.

Subsequently, the liquid crystal-coated surface side of the optically anisotropic layer (C1-3) of the laminated film (C1ABC) and the liquid crystal-coated surface side of the above-prepared laminated film (CM) were continuously bonded to each other using a pressure sensitive adhesive OPTERIA NCF-D692 (5 manufactured by Lintec Corporation) so that the longitudinal directions of the films were parallel to each other. Subsequently, the cellulose acylate film on the laminated film (C1ABC) side was peeled off to expose the optically anisotropic layer (C1-1). In this manner, an elongated laminated film (C1) in which the optically anisotropic layer (C1-1), the pressure sensitive adhesive layer, the optically anisotropic layer (C1-2), the pressure sensitive adhesive layer, the optically anisotropic layer (C1-3), the pressure sensitive adhesive layer, and the optically anisotropic layer (C1-4) were laminated in this order was obtained. The difference in refractive index between the pressure sensitive adhesive layer and each optically anisotropic layer was greater than 0.05.

Preparation of Circularly Polarizing Plate (PC1)

The surface of the optically anisotropic layer (C1-1) of the above prepared elongated laminated film (C1) and the surface of the polarizer (the surface opposite to the polarizer protective film) of the elongated linearly polarizing plate described in Example 1 were continuously bonded to each other using a pressure sensitive adhesive OPTERIA NCF-D692 (5 manufactured by Lintec Corporation). Subsequently, the cellulose acylate film on the optically anisotropic layer (C1-4) side was peeled off to expose the optically anisotropic layer (C1-4).

In this manner, a circularly polarizing plate (PC1) consisting of the laminated film (C1) and the linearly polarizing plate was prepared. At this time, the polarizer protective film, the polarizer, the optically anisotropic layer (C1-1), the optically anisotropic layer (C1-2), the optically anisotropic layer (C1-3), and the optically anisotropic layer (C1-4) were laminated in this order, and the angle formed by the absorption axis of the polarizer and the in-plane slow axis of the optically anisotropic layer (C1-2) was 76°. In addition, the in-plane slow axis direction on the surface of the optically anisotropic layer (C1-3) on the optically anisotropic layer (C1-2) side was 10°, with the width direction as a reference of 0°. The angle formed by the in-plane slow axis direction of the optically anisotropic layer (C1-3) and the in-plane slow axis direction of the optically anisotropic layer (C1-2) was 4°. In addition, the in-plane slow axis direction on the surface of the optically anisotropic layer (C1-3) on the optically anisotropic layer (C1-4) side was 95°, with the width direction as a reference of 0°.

### Comparative Example 2

Preparation of Laminated Film (C2)

The surface of the optically anisotropic layer (7-2) of the laminated film (7B) prepared by the method described in Example 7 was subjected to a corona treatment, and then the composition (C1-1) for forming an optically anisotropic layer described in Comparative Example 1 was applied using a geeser coating machine to form a composition layer. The film on which the composition layer was formed was heated with hot air at 116° C. for 1 minute. While purging with nitrogen to achieve an atmosphere with an oxygen concentration of 100 ppm by volume or less at a UV temperature of 78° C., UV irradiation (500 mJ/cm²) was carried out to immobilize the alignment of the liquid crystal compound to form an optically anisotropic layer (C2-1) corresponding to the first optically anisotropic layer.

The film thickness of the formed optically anisotropic layer (C2-1) was 0.9 μm. The in-plane retardation Re at a wavelength of 550 nm was 0 nm, and the thickness direction retardation Rth at a wavelength of 550 nm was 40 nm. It was confirmed that the average tilt angle of the disc plane of the disk-like liquid crystal compound with respect to the film surface was 0°, and the disk-like liquid crystal compound was horizontally aligned with respect to the film surface.

An elongated laminated film (C2) in which the optically anisotropic layer (C2-1), the optically anisotropic layer (7-2), the optically anisotropic layer (1-3), and the optically anisotropic layer (1-4) were laminated in this order was obtained by the above procedure. No pressure sensitive adhesive layer or adhesive layer was disposed between the optically anisotropic layers.

Preparation of Circularly Polarizing Plate (PC2)

The surface of the optically anisotropic layer (C2-1) of the above prepared elongated laminated film (C2) and the surface of the polarizer (the surface opposite to the polarizer protective film) of the elongated linearly polarizing plate described in Example 1 were continuously bonded to each other using a pressure sensitive adhesive OPTERIA NCF-D692 (5 μm, manufactured by Lintec Corporation). Subsequently, the cellulose acylate film on the optically anisotropic layer (1-4) side was peeled off to expose the optically anisotropic layer (1-4).

In this manner, a circularly polarizing plate (PC2) consisting of the laminated film (C2) and the linearly polarizing plate was prepared. At this time, the polarizer protective film, the polarizer, the optically anisotropic layer (C2-1), the optically anisotropic layer (7-2), the optically anisotropic layer (1-3), and the optically anisotropic layer (1-4) were laminated in this order, and the angle formed by the absorption axis of the polarizer and the in-plane slow axis of the optically anisotropic layer (7-2) was 76°. In addition, the in-plane slow axis direction on the surface of the optically anisotropic layer (1-3) on the optically anisotropic layer (7-2) side was 10°, with the width direction as a reference of 0°. The angle formed by the in-plane slow axis direction of the optically anisotropic layer (1-3) and the in-plane slow axis direction of the optically anisotropic layer (1-2) was 4°. In addition, the in-plane slow axis direction on the surface of the optically anisotropic layer (1-3) on the optically anisotropic layer (1-4) side was 95°, with the width direction as a reference of 0°.

### Comparative Example 3

A cholesteric liquid crystal laminate in which cholesteric liquid crystal layers Rm1, Gm1, and Bm1 are directly laminated and a V4 phase difference plate were prepared with reference to Example 1 of JP2018-087876A. The V4 phase difference plate had an in-plane retardation Re of 130 nm at a wavelength of 550 nm and a thickness direction retardation Rth of −5 nm at a wavelength of 550 nm. The cholesteric liquid crystal laminate and the V4 phase difference plate were bonded to each other by SK-Dyne to obtain a circularly polarizing plate (PC3). In a case where the transmittance spectrum of the light reflecting layer was measured using a spectrophotometer UV-3150 (manufactured by Shimadzu Corporation), a decrease in transmittance due to selective reflection of the cholesteric layer was observed at each wavelength of 650 nm, 550 nm, and 750 nm, and the minimum transmittance in a wavelength range of 400 to 700 nm was less than 60%.

Measurement of Optical Properties

Using AxoScan OPMF-1 (manufactured by Opto Science, Inc.) and at a wavelength of 550 nm, the light incidence angle dependence of Re and the tilt angle of the optical axis (that is, the tilt of the direction in which the refractive index of an optically anisotropic layer is maximized with respect to the surface of the optically anisotropic layer) were measured to obtain the in-plane retardation Re at a wavelength of 550 nm and the thickness direction retardation Rth at a wavelength of 550 nm of the optically anisotropic layer.

Measurement of Film Thickness

The thickness of the optically anisotropic layer was measured using a reflection spectroscopic film thickness meter FE3000 (manufactured by Otsuka Electronics Co., Ltd.).

Measurement of Refractive Index

A sample in which each optically anisotropic layer used in each of Examples and Comparative Examples was transferred onto glass using a pressure sensitive adhesive was prepared, the reflectance spectrum of the optically anisotropic layer was measured using a reflection spectroscopic film thickness meter FE3000 (manufactured by Otsuka Electronics Co., Ltd.), and the refractive index was calculated from the obtained reflectance spectrum. In a case of calculating the refractive index, a refractive index n at a wavelength of 550 nm was obtained by fitting the reflectance spectrum to the following Cauchy dispersion equation using the least-square method, under the assumption that the refractive indices of both interfaces of the optically anisotropic layer are equal. Here, C1, C2, and C3 are parameters of the n-Cauchy model, λ is a wavelength, and k is an attenuation coefficient. In addition, the thickness of the sample whose reflectance spectrum was measured was measured using a scanning electron microscope (S-4800, manufactured by Hitachi High-Technologies Corporation), and this measured value was used as the thickness at the time of fitting.

As described above, the refractive index calculated by the above corresponds to the refractive index ((nx+ny)/2) represented by Expression (N1).

$$n = \frac{{C}_{3}}{{λ}^{4}} + \frac{{C}_{2}}{{λ}^{2}} + {C}_{1} \\ k = 0$$

For the pressure sensitive adhesive layer and the adhesive layer, the refractive index was measured by the same method as described above.

Preparation of Organic EL Display Device

Mounting on Display Device

The SAMSUNG GALAXY S4 equipped with an organic EL panel was disassembled, a circularly polarizing plate was peeled off, and each of the circularly polarizing plates prepared in the foregoing Examples 1 to 10 and Comparative Examples 1 and 3 was bonded to the display device using a pressure sensitive adhesive SK-2057 (manufactured by Soken Chemical & Engineering Co., Ltd.) such that the polarizer protective film was arranged on the outside.

Evaluation of Display Performance

The prepared organic EL display device was brought into a black display state, observed from the front under bright light, and evaluated according to the following standards. The results are shown in Table 1 which will be described later.

A: Almost no reflected light is visible.

B: Reflected light is slightly visible.

C: Reflected light is visible, but it is acceptable.

D: Reflected light is large and it is unacceptable.

Evaluation of Point Defects

A λ/4 plate consisting of a polymerizable liquid crystal film was prepared by the method shown in paragraphs [0078] to [0086] of JP2021-124641A. The λ/4 plate had an in-plane retardation Re (550 nm) of 142.5 nm at a wavelength of 550 nm and Re (550 nm)/Re (550 nm) of 0.82. The prepared λ/4 plate was bonded to the linearly polarizing plate prepared by the method of Example 1 of the present invention, and the substrate of the λ/4 plate was peeled off to obtain a circularly polarizing plate (T1) for examination. In a case where the circularly polarizing plate (T1) for examination was observed from the λ/4 plate side, the slow axis of the λ/4 plate was rotated clockwise by −45° with respect to the absorption axis of the polarizing plate.

It was confirmed that, in a case where the circularly polarizing plate (T1) for examination and the circularly polarizing plate prepared in each of Examples 1 to 10 and Comparative Examples 1 to 3 were placed facing each other with the optically anisotropic layer inside, and stacked so that the absorption axis of the polarizing plate was 90°, light leakage was generally suppressed. In this state, white light was applied from the back surface to evaluate the frequency of defects having a size of 50 μm or more.

A: 2 defects/m² or less. (acceptable)

B: More than 2 defects/m² and 10 defects/m² or less. (acceptable)

C: More than 10 defects/m², which is unacceptable.

Difference in Refractive Index

Since the difference in refractive index between the pressure sensitive adhesive layer or adhesive layer and the optically anisotropic layer affects the display performance, it was evaluated according to the following standards. As for Example 3, the difference in refractive index between the pressure sensitive adhesive layer and the one optically anisotropic layer adjacent thereto was evaluated as C below, so it is indicated as “C” in Table 1 which will be described later.

A: The difference in refractive index between the pressure sensitive adhesive layer or the adhesive layer and the optically anisotropic layer adjacent thereto is 0.05 or less.

B: The difference in refractive index between the pressure sensitive adhesive layer or adhesive layer and the optically anisotropic layer is greater than 0.05 and less than or equal to 0.10.

C: The difference in refractive index between the pressure sensitive adhesive layer or adhesive layer and the optically anisotropic layer is more than 0.10.

Visible Light Transmittance

The surface of each of the laminated films (1) to (10) and (C1) to (C3) prepared in Examples 1 to 10 and Comparative Examples 1 to 3 opposite to the cellulose acylate film was bonded to a plate glass using a pressure sensitive adhesive SK-2057 (manufactured by Soken Chemical & Engineering Co., Ltd.), and the cellulose acylate film was peeled off to transfer the laminated film onto the glass.

Using a spectrophotometer (UV-3150 manufactured by Shimadzu Corporation) and using glass (EAGLE glass, manufactured by Corning Inc.) as a baseline, the transmittance of the laminated film transferred onto the glass was measured in a predetermined wavelength range (wavelength of 400 to 700 nm or 450 to 700 nm) at intervals of 10 nm, and the minimum transmittance in the predetermined wavelength range was evaluated according to the following standards.

A: The transmittance at the wavelength having the lowest transmittance in a predetermined wavelength range is more than 90%.

B: The transmittance at the wavelength having the lowest transmittance in a predetermined wavelength range is 90% or less and 60% or more.

C: The transmittance at the wavelength having the lowest transmittance in a predetermined wavelength range is less than 60%.

The column of “Number of pressure sensitive adhesive layers/adhesive layers” in the table indicates how many pressure sensitive adhesive layers or adhesive layers are disposed between the optically anisotropic layers, including between the first optically anisotropic layer and the second optically anisotropic layer, between the second optically anisotropic layer and the third optically anisotropic layer, and between the third optically anisotropic layer and the fourth optically anisotropic layer.

In the table, the column of “Pressure sensitive adhesive layer/adhesive layer refractive index” indicates the refractive index of the pressure sensitive adhesive layer or adhesive layer used.

TABLE 1

| | | Refractive | | | | | | | |
|---|---|---|---|---|---|---|---|---|---|
| | Number of | index of | | | | | | | |
| | pressure | pressure | | | | | Thickness of | Visible light | |
| | sensitive | sensitive | Thickness of | Refractive | Display | | circularly | transmittance | |
| | adhesive layers/ | adhesive layer/ | laminated | index | per- | Point | polarizing | 400 to | 450 to |
| | adhesive layers | adhesive layer | film | difference | formance | defect | plate | 700 nm | 700 nm |
| Example 1 | 1 | 1.59 | 5.6 μm | A | A | A | 49 μm | A | A |
| Example 2 | 1 | 1.51 | 5.6 μm | B | B | A | 49 μm | A | A |
| Example 3 | 1 | 1.48 | 9.5 μm | C | C | A | 52 μm | A | A |
| Example 4 | 1 | 1.59 | 5.8 μm | A | A | B | 49 μm | A | A |
| Example 5 | 1 | 1.59 | 5.8 μm | A | A | B | 49 μm | A | A |
| Example 6 | 1 | 1.59 | 5.8 μm | A | A | B | 49 μm | A | A |
| Example 7 | 1 | 1.59 | 5.8 μm | A | A | B | 49 μm | A | A |
| Example 8 | 1 | 1.59 | 5.8 μm | A | A | A | 69 μm | A | A |
| Example 9 | 1 | 1.59 | 6.6 μm | A | A | B | 50 μm | A | A |
| Example 10 | 1 | 1.59 | 5.3 μm | A | A | A | 49 μm | B | A |
| Comparative | 3 | 1.48 | 19.5 μm | C | D | A | 62 μm | A | A |
| Example 1 | | | | | | | | | |
| Comparative | 0 | — | 5.2 μm | — | A | C | 48 μm | A | A |
| Example 2 | | | | | | | | | |
| Comparative | 1 | — | 5.0 μm | — | D | — | 48 μm | C | C |
| Example 3 | | | | | | | | | |

As shown in the above table, the laminated film according to the embodiment of the present invention exhibited a desired effect.

From the comparison of Examples 1 to 3, it was confirmed that the effect was more excellent in a case where any one of the requirement Y1, Y2, or Y3 was satisfied.

From the comparison of Examples 1 to 3 with Examples 4 to 7, it was confirmed that the occurrence of point defects was further suppressed in a case where no alignment film was disposed between the two optically anisotropic layers.

### Explanation of References

10A, 10B, 10C: laminated film
12: first optically anisotropic layer
14: second optically anisotropic layer
16: third optically anisotropic layer
18: fourth optically anisotropic layer
20: adhesion layer

What is claimed is:

1. A laminated film comprising:
a first optically anisotropic layer;
a second optically anisotropic layer;
a third optically anisotropic layer; and
a fourth optically anisotropic layer in this order,
wherein the first optically anisotropic layer, the second optically anisotropic layer, the third optically anisotropic layer, and the fourth optically anisotropic layer are each a layer formed by fixing an aligned liquid crystal compound,
an adhesion layer selected from the group consisting of an adhesive layer and a pressure sensitive adhesive layer is provided only one of between the first optically anisotropic layer and the second optically anisotropic layer, between the second optically anisotropic layer and the third optically anisotropic layer, and between the third optically anisotropic layer and the fourth optically anisotropic layer, and
the laminated film has a minimum transmittance of 60% or more in a wavelength range of 400 to 700 nm.

2. The laminated film according to claim 1,
wherein the laminated film satisfies one or two of the following requirements X1 to X3,
Requirement X1: the first optically anisotropic layer and the second optically anisotropic layer are in direct contact with each other or are laminated through an alignment film, and an alignment direction of the liquid crystal compound on a surface of the first optically anisotropic layer on a second optically anisotropic layer side and an alignment direction of the liquid crystal compound on a surface of the second optically anisotropic layer on a first optically anisotropic layer side are different from each other,
Requirement X2: the second optically anisotropic layer and the third optically anisotropic layer are in direct contact with each other or are laminated through an alignment film, and an alignment direction of the liquid crystal compound on a surface of the second optically anisotropic layer on a third optically anisotropic layer side and an alignment direction of the liquid crystal compound on a surface of the third optically anisotropic layer on the second optically anisotropic layer side are different from each other,
Requirement X3: the third optically anisotropic layer and the fourth optically anisotropic layer are in direct contact with each other or are laminated through an alignment film, and an alignment direction of the liquid crystal compound on a surface of the third optically anisotropic layer on a fourth optically anisotropic layer side and an alignment direction of the liquid crystal compound on a surface of the fourth optically anisotropic layer on the third optically anisotropic layer side are different from each other.

3. The laminated film according to claim 1,
wherein the laminated film satisfies any one of the following requirement Y1, Y2, or Y3,
Requirement Y1: the adhesion layer is disposed between the first optically anisotropic layer and the second optically anisotropic layer, a difference between a refractive index of the adhesion layer and a refractive index of the first optically anisotropic layer is 0.10 or less, and a difference between the refractive index of the adhesion layer and a refractive index of the second optically anisotropic layer is 0.10 or less,
Requirement Y2: the adhesion layer is disposed between the second optically anisotropic layer and the third optically anisotropic layer, the difference between the refractive index of the adhesion layer and the refractive index of the second optically anisotropic layer is 0.10 or less, and a difference between the refractive index of the adhesion layer and a refractive index of the third optically anisotropic layer is 0.10 or less,
Requirement Y3: the adhesion layer is disposed between the third optically anisotropic layer and the fourth optically anisotropic layer, the difference between the refractive index of the adhesion layer and the refractive index of the third optically anisotropic layer is 0.10 or less, and a difference between the refractive index of the adhesion layer and a refractive index of the fourth optically anisotropic layer is 0.10 or less.

4. The laminated film according to claim 1,
wherein the first optically anisotropic layer and the second optically anisotropic layer are in direct contact with each other, the adhesion layer is disposed between the second optically anisotropic layer and the third optically anisotropic layer, and the third optically anisotropic layer and the fourth optically anisotropic layer are in direct contact with each other.

5. The laminated film according to claim 1,
wherein the adhesion layer is a layer formed of an ultraviolet curable adhesive.

6. The laminated film according to claim 1,
wherein the laminated film has a thickness of 20 μm or less.

7. The laminated film according to claim 1,
wherein the laminated film has an in-plane retardation of 100 to 180 nm at a wavelength of 550 nm.

8. A circularly polarizing plate comprising:
the laminated film according to claim 1; and
a polarizer.

9. The circularly polarizing plate according to claim 8,
wherein a polymer film is not provided between the laminated film and the polarizer.

10. A display device comprising:
the laminated film according to claim 1.

11. A display device comprising:
the circularly polarizing plate according to claim 8.

12. The laminated film according to claim 2,
wherein the laminated film satisfies any one of the following requirement Y1, Y2, or Y3,
Requirement Y1: the adhesion layer is disposed between the first optically anisotropic layer and the second optically anisotropic layer, a difference between a refractive index of the adhesion layer and a refractive index of the first optically anisotropic layer is 0.10 or less, and a difference between the refractive index of the adhesion layer and a refractive index of the second optically anisotropic layer is 0.10 or less,
Requirement Y2: the adhesion layer is disposed between the second optically anisotropic layer and the third optically anisotropic layer, the difference between the refractive index of the adhesion layer and the refractive index of the second optically anisotropic layer is 0.10 or less, and a difference between the refractive index of the adhesion layer and a refractive index of the third optically anisotropic layer is 0.10 or less,
Requirement Y3: the adhesion layer is disposed between the third optically anisotropic layer and the fourth optically anisotropic layer, the difference between the refractive index of the adhesion layer and the refractive index of the third optically anisotropic layer is 0.10 or less, and a difference between the refractive index of the adhesion layer and a refractive index of the fourth optically anisotropic layer is 0.10 or less.

13. The laminated film according to claim 2,
wherein the first optically anisotropic layer and the second optically anisotropic layer are in direct contact with each other, the adhesion layer is disposed between the second optically anisotropic layer and the third optically anisotropic layer, and the third optically anisotropic layer and the fourth optically anisotropic layer are in direct contact with each other.

14. The laminated film according to claim 3,
wherein the first optically anisotropic layer and the second optically anisotropic layer are in direct contact with each other, the adhesion layer is disposed between the second optically anisotropic layer and the third optically anisotropic layer, and the third optically anisotropic layer and the fourth optically anisotropic layer are in direct contact with each other.

15. The laminated film according to claim 2,
wherein the adhesion layer is a layer formed of an ultraviolet curable adhesive.

16. The laminated film according to claim 3,
wherein the adhesion layer is a layer formed of an ultraviolet curable adhesive.

17. The laminated film according to claim 4,
wherein the adhesion layer is a layer formed of an ultraviolet curable adhesive.

18. The laminated film according to claim 2,
wherein the laminated film has a thickness of 20 μm or less.

19. The laminated film according to claim 3,
wherein the laminated film has a thickness of 20 μm or less.

20. The laminated film according to claim 4,
wherein the laminated film has a thickness of 20 μm or less.
